(19) United States
(12) Patent Application Publication
(10) Pub. No.: US 2023/0216682 A1
(43) Pub. Date: Jul. 6, 2023

(54) MANAGING THE CONSISTENCY OF DIGITAL ASSETS IN A METAVERSE

(71) Applicant: Numéraire Financial, Inc., Chicago, IL (US)

(72) Inventors: Alexander Lipton, Chicago, IL (US); Thomas P. HARDJONO, Winchester, MA (US)

(73) Assignee: Numéraire Financial, Inc., Chicago, IL (US)

(21) Appl. No.: 18/147,502

(22) Filed: Dec. 28, 2022

Related U.S. Application Data
(60) Provisional application No. 63/295,363, filed on Dec. 30, 2021.

(51) Int. Cl. H04L 9/32; H04L 9/08; G06T 19/00; G06T 13/40

(52) U.S. Cl. CPC H04L 9/3213; H04L 9/0825; G06T 19/006; G06T 13/40

(57) ABSTRACT

Techniques are described for a system architecture, protocols, tokens, and other data structures used to manage the consistency of the state of digital assets and their ownership across one or more metaverse realms (e.g., interactive digital worlds). A digital asset in the form of a token (e.g., a token stored on a decentralized ledger) can be bound to real world physical assets (including physical objects of value) and at the same time can also be bound to a visual symbol or a pictograph (e.g., an avatar) in one or more metaverse realms. In some examples, it is desirable for any changes to the state or ownership of the asset in one of the three realms (that is, in the physical real-world, in the form of a token on a decentralized ledger, or as a digital representation within a metaverse) to also be reflected in the other two realms.

### BACKGROUND

There is a growing interest in metaverses and other virtual world-related platforms. Broadly, these technologies enable the creation of alternative digital universes in which users can participate. Many of these metaverses and other digital universes enable users to create an avatar representing the user (e.g., a graphical image, or a three-dimensional model, etc.) while the user engages with the digital universe and with other users.

Distributed ledger technology refers broadly to the infrastructure and protocols used to provide distributed ledgers. Distributed ledgers represent a consensus of replicated, shared, and synchronized data that is stored across different sites and geographies by multiple participants. In contrast to centralized ledgers or databases, distributed ledgers generally are not associated with any central authority and updates made to the ledger are reflected and copied to all participants using a consensus algorithm. The security of distributed ledgers is achieved in part using cryptographic keys and digital signatures.

### BRIEF DESCRIPTION OF THE DRAWINGS

Illustrative examples are described in detail below with reference to the following figures:

FIG. 1 is a diagram illustrating an overview of a networked computing environment including an asset consistency management system and one or more metaverses providing networked virtualized computing communities according to some examples.

FIG. 2 is a diagram illustrating an overview of singularity assets and duality assets in the context of an asset consistency management system according to some examples.

FIG. 3A is a diagram illustrating an overview of a composite singularity asset in the context of an asset consistency management system according to some examples.

FIG. 3B is a diagram illustrating an overview of a composite duality asset, which includes a real-world component, in the context of an asset consistency management system according to some examples.

FIG. 4 is a diagram illustrating an overview of the problem of identity-validation and object-authenticity verification in a metaverse according to some examples.

FIG. 5 is a diagram illustrating a cross-metaverse double-spend scenario in which a duality-asset is sold twice in different metaverses according to some examples.

FIG. 6 is a diagram illustrating a summary of a metaverse singularity asset definition data structure supporting composite assets according to some examples.

FIG. 7 is a diagram illustrating a summary of the metaverse duality asset definition data structure supporting N composite assets according to some examples.

FIG. 8A is a diagram illustrating an example of a singularity asset instance including a single metaverse asset according to some examples.

FIG. 8B is a diagram illustrating an example of a singularity asset instance consisting of a composite of two or more metaverse assets according to some examples.

FIG. 9 is a diagram illustrating an example of a duality asset instance, which is a composite of two pairs (or “dualities”) of assets, according to some examples.

FIG. 10 is a diagram illustrating a summary of a waterfall ledger architecture according to some examples.

FIG. 11 is a diagram illustrating an overview of the type of keys used in an asset consistency management system according to some examples.

FIG. 12 is a diagram illustrating an overview of the asset ownership token data structure for a given asset instance on an asset trading ledger according to some examples.

FIG. 13 is a diagram illustrating an overview of a user avatar ownership token data structure on the asset trading ledger according to some examples.

FIG. 14 is a diagram illustrating an overview of a user avatar state token data structure on the tracking ledger according to some examples.

FIG. 15 is a diagram illustrating an overview of an object avatar state token data structure according to some examples.

FIG. 16 is a diagram illustrating an example of two object avatar state tokens that have been registered on the tracking ledger and are deployed in different metaverses according to some examples.

FIG. 17 is a diagram illustrating an overview of a physical object state token data structure according to some examples.

FIG. 18 is a diagram illustrating an overview of a metaverse duality event and a duality ticket asset instance according to some examples.

FIG. 19 is a diagram illustrating an overview of a duality ticket asset instance on the asset trading ledger according to some examples.

FIG. 20 is a diagram illustrating an overview of a metaverse authentication protocol (or “MAuth”) message flows according to some examples.

FIG. 21 is a diagram illustrating an overview of the authentication receipt data structure that contains links to the challenge parameter and response parameter data structures on the tracking ledger according to some examples.

FIG. 22 is a diagram illustrating an overview of the payloads of the challenge response and response messages for user-avatar authentication according to some examples.

FIG. 23 is a diagram illustrating an overview of the payloads of a challenge response and response messages for branded object-avatar authentication according to some examples.

FIG. 24 is a diagram illustrating an overview of an asset trading protocol for a duality asset instance according to some examples.

FIG. 25 is a flow diagram illustrating operations of a method for providing an asset trading protocol involving asset instances used in one or more metaverses according to some examples.

FIG. 26 is a block diagram illustrating an example computer system that may be used in some examples.

### DETAILED DESCRIPTION

The present disclosure relates to methods, apparatus, systems, and non-transitory computer-readable storage for a system architecture, protocols, types of tokens, and other data structures used to manage the consistency of the state of virtual or digital assets and their ownership across one or more metaverse realms (e.g., interactive digital worlds). A digital asset in the form of a token (e.g., a token stored on a decentralized ledger) can be bound to real world physical assets (including physical objects of value) and at the same time can also be bound to a visual symbol or a pictograph (e.g., an avatar) in one or more metaverse realms. In some examples, it is desirable for any changes to the state or ownership of the asset in one of the three realms (that is, in the physical real-world, in the form of a token on a decentralized ledger, or as a digital representation within a metaverse) to also be reflected in the other two realms.

In some examples, a metaverse can include a networked and computer-implemented virtualized community that permits users to interact with one another using digital avatars or other graphical representations (within the confines of the virtualized computing systems or network). For example, metaverses can include any type of virtual shared space such as social networking environments, gaming environments, educational environments, augmented reality (AR) environments, or any other virtual world involving user interaction. A metaverse can further include various types of metaverse assets. A metaverse asset, for example, can include non-fungible digital assets that are available for ownership and trading within a metaverse. A metaverse asset can include a combination of: (i) unique bytes of data representing the asset (e.g., an image file or other collection of data that can be rendered by a computing device to produce an image for human visual recognition on a display screen), (ii) issuance/creation of the asset by an entity (person or organization), and (iii) an association with one or more specific networked virtualized computing environments (e.g., a specific metaverse(s)), which together define a metaverse asset.

In some examples, an object metaverse asset can take the form of an object which can be legally purchased or traded by users. Once an object metaverse asset is legally acquired by a person or entity, for example, the asset typically belongs to the person or entity until the owner sells or trades the asset. Generally, there are at least two categories of object metaverse assets in a metaverse, namely, singularity assets and duality assets, as described in more detail herein.

In some examples, another type of metaverse asset is a venue access asset. A venue access asset, for example, can include access to a “meta-venue” within a metaverse. A user or other entity can, in some examples, obtain (e.g., purchase or trade for) a venue access token, where a venue access token has a time limit of validity (e.g., for a given event in the venue). In some examples, access to a meta-venue in a metaverse can be coupled with access to a physical venue (e.g., a concert theater) in the real world. A meta-venue, for example, represents a private area or a resource within a metaverse that is controlled by a venue owner. A meta-venue can correspond to a physical venue in the real world, e.g., such that a user's ability to access to one can automatically confer access to the other.

In some examples, singularity assets represent a category of metaverse assets that are solely digital in format and have no corresponding physical asset in the real world. A singularity asset exists only within a metaverse or within multiple metaverses. Duality assets represent another category of metaverse assets that exist in both a metaverse and in the real world, where a metaverse asset and a corresponding real-world asset are inseparably interlinked (or bound) with one another. Destruction of a duality asset in one world (e.g., in a metaverse) can, in some examples, also imply destruction of the asset in the other world (e.g., in the real world, or vice versa).

In some examples, an asset definition authority (or “ADA”) is a legal entity that can define what constitutes an asset in the metaverse world (for both singularity and duality assets) and publishes the definition in a source-authentic way. An asset issuer, in some examples, is a legal entity that makes singularity assets and duality assets available to buyers within a metaverse. Note that a brand owner can be an asset issuer (and can, e.g., issue branded assets carrying or otherwise evidencing an association with a particular brand of goods or services).

In some examples, a metaverse avatar is a graphical representation of a person, object, or venue within a metaverse. A metaverse can be associated with a network identifier representing a globally unique identifier for a given metaverse. A metaverse can be operated by a metaverse network owner or operator, which is a legal entity that owns and/or operates a networked virtualized computing environment implementing metaverse capabilities.

In some examples, a user avatar is a graphical digital representation of a human user employed within a metaverse. A user avatar controller is a person or entity controlling a user avatar within a metaverse. In some examples, an object avatar is a graphical digital representation of physical objects employed within a metaverse. For example, an object avatar can include a clothing item (e.g., a shirt, a hat, shoes, and the like), an accessory displayed in connection with a user avatar (e.g., a bag, jewelry, eyewear, and the like), a usable object (e.g., a weapon, a shield, gaming rewards, and the like), or any other objects relevant in various types of metaverses. An object avatar controller is a person or entity controlling an object avatar within a metaverse.

In some examples, a venue avatar is a graphical digital representation of a contained space (in 2-dimensions or 3-dimensions) used within a metaverse. A venue avatar controller is a person or entity controlling a venue avatar within a metaverse. In some examples, an event-avatar is a graphical digital representation of a time-bound event or happening in the metaverse. In some examples, a branded event-avatar is an event-avatar that is associated with a given brand, brand owner, and venue. In some examples, personal object avatars include object avatars created by a user and which may not bear a formal brand or trademark. In some examples, a branded object avatar includes an object avatar that is created by a brand owner (or manufacturer or other entity) who issued an asset (e.g., a singularity or duality asset) bound to that avatar graphical digital representation. A branded object avatar sometimes can be associated with one or more registered trademarks or other intellectual property of a brand owner. In some examples, a metaverse branded asset includes a metaverse asset that is issued by a brand owner and is associated with the brand value of that brand owner. In the metaverse, the branded asset can be represented by a branded object avatar bearing the graphical symbols (e.g., a trademark logo) of the brand. A given metaverse branded asset is cryptographically bound to the asset instance. In some examples, a branded venue avatar includes a venue avatar that is created by a venue owner as a business legal entity. The venue owner controls who can access (e.g., enter) the contained space within a metaverse.

In some examples, a metaverse asset bearer includes a person or legal entity who digitally displays (or otherwise bears) a metaverse asset in graphical form within a given metaverse. For example, a user who utilizes a “Pink Panther®” avatar in a metaverse may show a “Gucci®-Gold-Bag” object avatar that conveys the fact that the person owns that Gucci® branded bag singularity or duality asset. In some examples, a manufacturer of real-world assets is a legal entity that manufactures physical goods considered as real-world assets. For example, a manufacturer can produce goods for a brand owner. In some examples, a brand owner of assets is a legal entity who owns the trademark and brand for real-world assets and as well as metaverse assets (e.g., singularity assets and duality assets).

### Digital Assets in the Metaverse

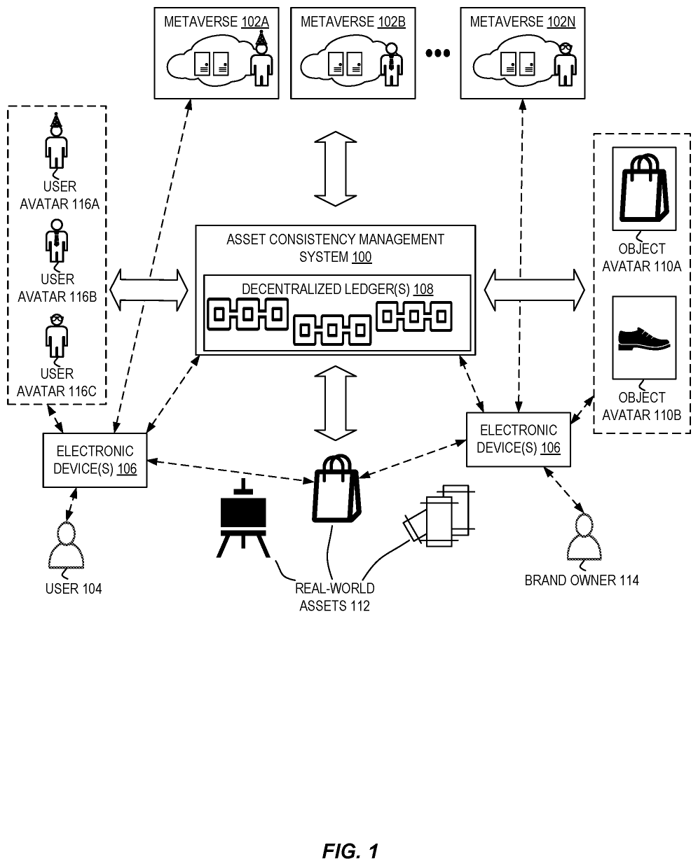

There is a growing interest in defining digital assets (including digital representations of real-world assets) within metaverses with a goal of permitting user behaviors to be conducted in the metaverse on these assets. FIG. 1 is a diagram illustrating an overview of a networked computing environment including an asset consistency management system and one or more metaverses providing networked virtualized computing communities according to some examples.

As shown in FIG. 1, according to examples described herein, an asset consistency management system 100 (also referred to herein as an “ACMS”) is provided to enable entities to ensure the consistency and security of the digital assets that are present and exchanged within one or more metaverses (e.g., a metaverse 102A, a metaverse 102B, . . . , a metaverse 102N). In some examples, the asset consistency management system 100 enables users (such as, e.g., a user 104 using electronic device(s) 106, where the electronic device(s) 106 can include, e.g., a desktop computer, a laptop, a mobile device, or the like) to view, modify, and confirm transactions stored on the decentralized ledger(s) 108 of the asset consistency management system 100, among other possible actions. In some examples, some or all the decentralized ledgers 108 of the asset consistency management system 100 can include public, private, or hybrid decentralized ledgers. For example, a private or hybrid ledger can be configured such that access to the ledger is limited to a specified set of users (e.g., users registered with the asset consistency management system 100 or one or more associated metaverses). In some examples, users can access the ledgers and other components of the asset consistency management system 100 via a client application running on an electronic device 106, via applications used to access one or more metaverses, or using other types of applications of services. In other examples, the asset consistency management system 100 can use other types of data stores such as databases, object stores, and the like, which can be implemented using on-premises or cloud-based computing resources (e.g., provided by various services of a cloud provider network). As shown, users can interact within the metaverses using various user avatars (e.g., such as user avatar 116A, user avatar 116B, and user avatar 116C).

The asset consistency management system 100 can also include additional network-accessible functionality (e.g., via one or more application programming interfaces (APIs)). Users can access the asset consistency management system 100 and other components through API calls, via an application or website, etc. Here, an API refers to a communication protocol between a client and a server, where the client can make requests in one or more defined formats and the server can send a response in a specific format or initiate a defined action. For example, the asset consistency management system 100 can provide APIs for initiating the registration of singularity and duality assets on one or more ledgers 108, mediating aspects of authenticating users, user avatars, objects, object avatars, venues, venue avatars, etc., and of facilitating sales or trades of metaverse assets, and the like. In some examples, some or all the components of the asset consistency management system 100 can be incorporated as part of the implementation of one or more metaverses (e.g., metaverse 102A, metaverse 102B, . . . , metaverse 102N) or implemented entirely separately from any of the metaverses. In some examples, an electronic device 106 can include a computer system that employs a tamper-resistant, secure cryptographic hardware that permits the user to manage and utilize keys that are relevant to interacting with the asset consistency management system 100, including the decentralized ledgers 108. The tamper-resistant secure cryptographic hardware permits a user to manage and use the keys that are bound to their assets and tokens that are accessible through the asset consistency management system 100.

### Metaverse Assets: Objects and Venues

In a metaverse, an asset can be represented by a set of data (e.g., a set of bytes) that form a digital image, a three-dimensional (3D) model, or other visual representation of a real-world object (e.g., object avatar 110A and object avatar 110B, each of which may correspond to one or more real world assets 112 such as clothing, jewelry, accessories, art, or any other physical objects). Furthermore, the object avatars and real-world assets may be associated with one or more brand owners (e.g., a brand owner 114) that can access the asset consistency management system 100 to register assets, managed registered assets, etc. An asset typically has economic value due to a combination of factors, including the origins or provenance of the asset, the scarcity of the asset, and/or the metaverse where the asset is available. In some examples, a pure metaverse asset can include a combination of (i) the unique bytes of data (e.g., an image file in standard format) referred to as an “avatar”, (ii) issued by an entity recognized in the metaverse, and (iii) for a specific networked virtualized computing environment (also referred to as a metaverse).

Thus, in a metaverse, an asset can include the image file (e.g., a JPEG object avatar file) or any other type of digital data that can be rendered by an application to visually represent an object to the human eye/mind. An owner of a pure metaverse asset can upload the object avatar image file or other data into a metaverse, associate the object avatar to its own user avatar, and wield or wear the object avatar throughout a metaverse. This can convey to the other users in the metaverse, for example, that the wielder is the legal owner of the pure metaverse asset.

As indicated, in some examples, metaverse assets can be further divided into at least two classes, namely, object metaverse assets and venue access assets. In some examples, an object metaverse asset is a type of metaverse asset that takes the form of an object facsimile (e.g., an image file or other data representing the object) which can be legally purchased or traded by a user. Once an object asset is legally acquired by a person or entity, it generally belongs to the person or entity until such time that the owner sells or trades it.

In some examples, a venue access asset is a type of metaverse asset that consists of access to a meta-venue within the metaverse. In some examples, a user or other entity obtains (e.g., purchases or trades for) a venue access token, which has a time limit of validity (e.g., corresponding to a given event in the meta-venue). In some examples, access to a meta-venue in a metaverse can be coupled with access to a physical venue (e.g., a concert theater) in the real-world. As indicated herein, a meta-venue is a private area or resource within a metaverse that is controlled by a venue owner. It may be bound to a physical venue in the real-world, e.g., so that access to one automatically provides access to the other.

In some examples, a metaverse asset can be referred to as a “singularity asset” when the metaverse asset exists solely (or singularly) in the metaverse computing world. A metaverse asset can instead be referred to as a “duality asset” when it is bound (e.g., cryptographically) to a physical object or physical venue in the real-world. The type of a metaverse asset (e.g., singularity or duality) has implications to the ownership of the asset, or access to the asset.

In some examples, compositions of pure (singularity) metaverse assets and compositions of duality assets can be made. For example, the term “composite” is used herein to mean a collection or set which together makeup the definition of the asset.

### Singularity Assets and Duality Assets

In the following, a distinguishment is made between digital assets that are available: (i) only within one (or more) metaverses without any real-world equivalent, and (ii) digital assets in a metaverse which are cryptographically bound to one or more specific physical real-world assets. In some examples, the term singularity asset is used for the first case whereas the term duality asset for the latter case.

A singularity asset refers to the case of the pure metaverse asset, as described elsewhere herein. For this type of asset, the digital representation (such as an avatar image file or other data used to render a graphical representation of the asset) is the asset itself within a given metaverse (or one or more specified metaverses). The manufacturer of the pure metaverse asset (i.e., an entity that created the avatar image JPEG file) may embed a unique serial number within the image file, for example, as digital watermark in the image file. For example, the avatar image of a physical object (e.g., products, goods, artwork, etc.) is the thing (set of bytes) that is defined to be an asset. A singularity asset is a not bound to any real-world objects or persons and exists only within the metaverse(s) for which it is designed to exist. A singularity asset can be defined to exist in one metaverse only, or it can be defined to be movable across multiple metaverses.

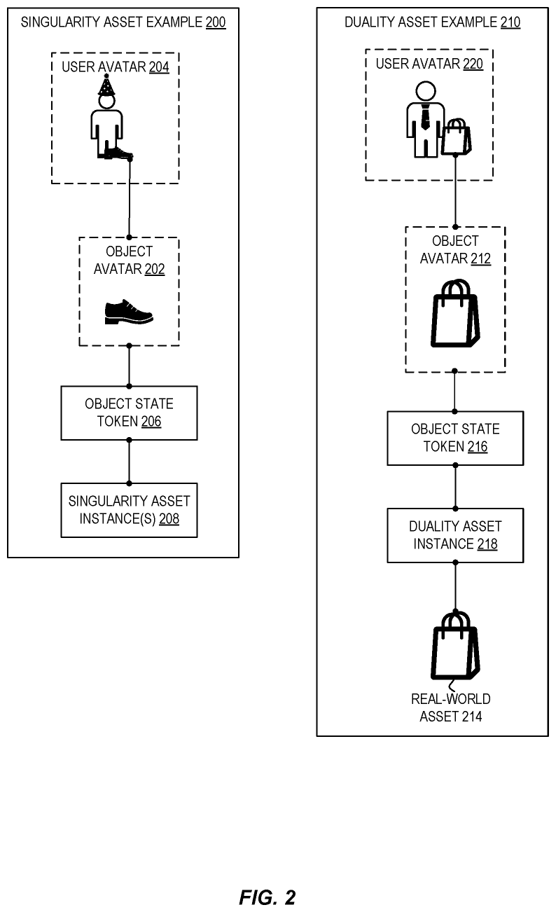

FIG. 2 is a diagram illustrating an overview of singularity assets and duality assets in the context of an asset consistency management system according to some examples. The singularity asset example 200 in FIG. 2 includes an object avatar 202 that is a computer image facsimile of an article of clothing (e.g., a yellow shoe associated with a specific real-world brand). The object avatar 202 is designed to exist only in the metaverse in limited quantities (e.g., to be displayed in association with one or more user avatars, such as user avatar 204). In this example, the issuer/producer of the object avatar 202 has not bound it to any real-world asset. As described in more detail herein, an object avatar 202 can be associated with an object state token 206 and one or more singularity asset instances 208.

In some examples, a duality asset example 210 illustrates a case where an asset is defined to consist of a combination of a pure metaverse asset (e.g., an object avatar 212) and a real-world physical object (e.g., a real-world asset 214). In this example, the digital image (e.g., JPEG avatar image file) representation of the asset in the metaverse is bound (e.g., cryptographically) to a real-world object in some manner. In some examples, a change of ownership (e.g., through a sale) of a duality asset implies change of ownership of both the pure metaverse asset and the real-world physical object (e.g., an entity that owns a duality asset owns both the object avatar and the corresponding real-world object). In some examples, by definition, a duality asset cannot be separated by its current owner.

Referring again to FIG. 2, a brand manufacturer of luxury goods can create a limited edition of physical goods/objects (e.g., a real-world asset 214, which can be a leather handbag or any other type of physical object) in the real world and at the same time issue a limited edition object avatar digital representation of the goods (e.g., object avatar 212 of the handbag). In this example, there is a one-to-one matching between an instance of the real-world asset 214 and the instance of an object avatar 212 image in the metaverse. As described in more detail hereinafter, this association can be maintained via an object state token 216, duality instance 218, and other mechanisms. As further illustrated, a duality asset can also be displayed in association with a user avatar 220 in one or more metaverses.

As another example of a duality asset, an artist may create a digital artwork (e.g., large digital painting) that can be displayed on a large computer/digital screen on the wall. The artist may produce one (1) instance of this digital artwork. At the same time, the artist may also issue one avatar image corresponding to the large digital artwork. In some examples, the asset consistency management system 100 can maintain a one-to-one correspondence between these two forms of the digital artwork.

### Composite Singularity Assets and Composite Duality Assets

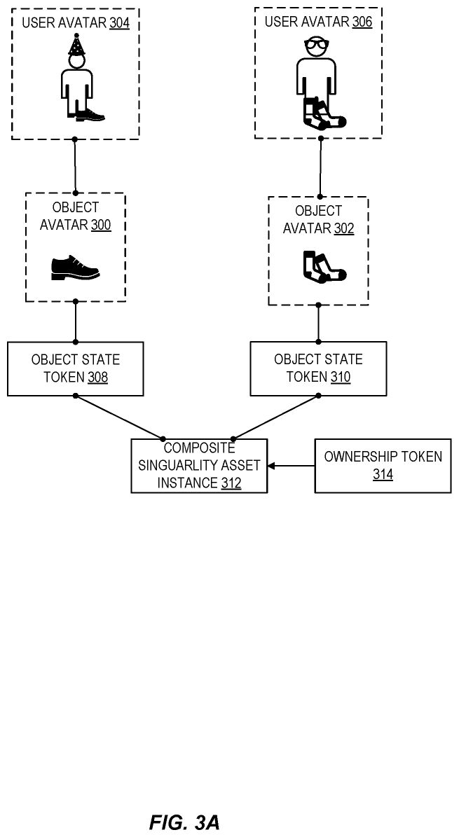

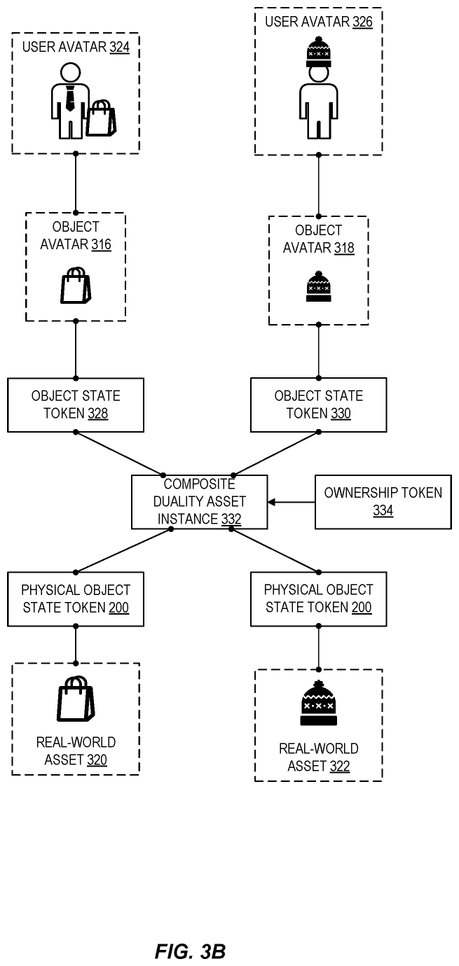

In some examples, a further extension to the notion of singularity or duality assets is that of a composite singularity asset or composite duality asset. FIG. 3A and FIG. FIG. 3B illustrates examples of composite singularity assets and composite duality assets, respectively, according to some examples.

In some examples, a composite singularity asset refers to instances where two or more singularity assets are treated as a collection or set within one or more metaverses. The implication is that the ownership of a composite singularity asset means ownership of all the component singularity assets that make up the composite. The owner of the composite singularity asset has the freedom to display the avatars (of each of the component assets) within separate metaverses, but any trade/sale of the composite singularity asset implies sale of the entire collection/set.

An example is shown in FIG. 3A, where a composite singularity asset consists of two (2) singularity assets represented by the object avatar 300 (e.g., “Super Sneakers”) and object avatar 302 (e.g., “Super Socks”). The owner of the composite singularity asset has chosen to show one item with user avatar 304 while the other item with user avatar 306, both of which are under the control of the owner in one or more metaverses. As shown, each of the object avatars is associated with an object state token 308 and an object state token 310, respectively, which together can be associated with a composite singularity asset instance 312. The ownership of the composite singularity asset instance 312 can be evidenced by an ownership token 314.

In some examples, a composite duality asset refers to instances where two or more duality assets are treated as a collection or set within one or more metaverses. Each of the component assets are associated with a real-world asset. In some examples, ownership of a composite duality asset includes the ownership of all the component duality assets and the real-world assets that make up the composition. The trade/sale of the composite duality asset implies sale of the entire collection/set (including the assets in both the metaverse and the assets in the real-world).

An example is shown in FIG. 3B, where the object avatar 316 (e.g., a “Gucci® Bag”) and object avatar 318 (e.g., a “Gucci® Hat”) are bound to the physical real-world asset 320 (e.g., a physical bag) and real-world asset 322 (e.g., a physical hat), respectively. As shown, the object avatars can be wielded by user avatar 324 and user avatar 326, respectively, across one or more metaverses. As shown, each of the object avatars is associated with an object state token 328 and object state token 330, respectively, which together can be associated with a composite duality asset instance 332. The ownership of the composite duality asset instance 332 can be evidenced by an ownership token 334.

### Ownership and Sale of Singularity and Duality Assets

When a metaverse asset changes ownership (e.g., through a sale of the asset), in some examples, a metaverse asset trading protocol is employed to ensure the consistency of the states of the objects in the metaverse and the real world. The details of an example metaverse asset trading protocol are described in more detail elsewhere herein.

When a singularity asset changes possession from one party to another, in some examples, a copy of the unmodified object avatar data (e.g., a JPEG file or other digital representation) is provided to the buyer by the seller. The seller is also to delete or otherwise render the object avatar data unusable. In some examples, a buyer (or any entity) can validate the correctness of the object avatar image file by computing a cryptographic hash of the object avatar image file and comparing the cryptographic hash to the hash value asset instance defined by the manufacturer on an asset trading ledger. Alternatively, the buyer can obtain a copy of the object avatar image file directly from the brand owner or manufacturer that originally created the object avatar image.

In the case of a duality asset, in some examples, the corresponding real-world physical object (e.g., a physical luxury handbag or other type of object) is first brought by the owner of the duality asset to a depository entity, where the depository entity validates its authenticity against the data at the manufacturer. The depository entity can be a true asset depository entity (of any kind of asset), or it can be an authorized dealer of the manufacturer. Once the depository entity is satisfied as to the condition of the real-world physical object (e.g., that the object is not a counterfeit), in some examples, the depository entity issues a depository receipt for that item object onto the physical logistics ledger.

In some examples, a depository receipt is used to signal (e.g., to potential buyers) that a real-world physical object is in the hands of a neutral entity and that the sale of the duality asset can proceed on the asset trading ledger. In some examples, a potential buyer of a duality asset ensures beforehand that the real-world physical object (part of the duality asset) resides in the hands of a neutral depository entity.

### Detecting Counterfeit Singularity and Duality Assets

It is worth noting that a dishonest prior owner of a singularity/duality asset potentially can keep an unpermitted copy of object avatar data (e.g., that can be used to render the object avatar for display) after its sale to another party. The dishonest prior owner could then, for example, upload the object avatar data into a metaverse and wield it around the metaverse (e.g., pretending to be a current legitimate owner). In other words, the dishonest user could wield a “counterfeit” object avatar to the detriment of the brand owner (e.g., manufacturer) of the singularity/duality asset and to the detriment of the current legitimate owner of the asset.

In order to detect a counterfeit object-avatar image file, in some examples, a user who wields a singularity asset (e.g., an object-avatar image file) in the metaverse can be “challenged” by any other party in the metaverse to prove the authenticity and ownership of the singularity asset. An object avatar authentication protocol and a user avatar authentication protocol are described elsewhere herein.

### Managing Digital Assets in the Metaverse

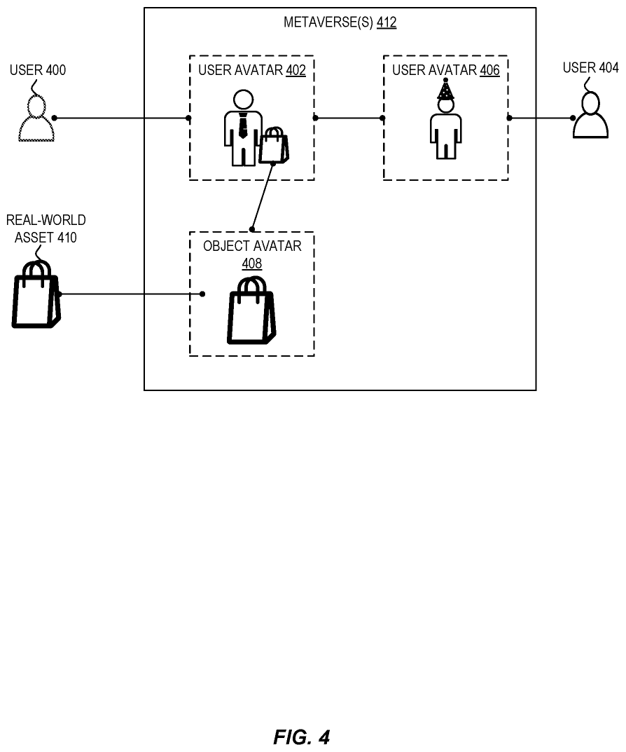

There are several challenges in dealing with singularity assets in the metaverse and duality assets that are tied to real-world assets. Further, there are several challenges relating the use of digital representations or persons (user avatars) and asset or resource digital representations (object avatars) within a given metaverse. FIG. 4 is a diagram illustrating an overview of the problem of identity-validation and object-authenticity verification in a metaverse according to some examples.

(a) Mutual authentication of avatars and owners within a given metaverse: As one example, it is desirable for there to be a mechanism to prove (e.g., to other parties) that a user owns and controls their user avatar(s) within one or more metaverse(s). For example, when a user 400 employs a user avatar 402 in one or more metaverse(s) 412, there is a possibility that the same user avatar 402 (e.g., a same image or digital representation) may be used (unauthorized copying) by attackers/hackers either within the same metaverse or within different metaverses. It is thus desirable for there to be a mechanism for user 400 to prove ownership/control of user avatar 402. Similarly, the mechanism can be used by user 404 to prove control/ownership of user avatar 406.

(b) Validation of the authenticity of assets represented by object avatars: It is further desirable for there to be a mechanism to allow any party to prove that an object avatar is a genuine asset produced by a manufacturer or asset issuer. This mechanism can be used in both cases of singularity assets and duality assets. In the case of a duality asset, it is additionally desirable for there to be a mechanism to prove that there is a one-to-one correspondence between an object avatar and its corresponding real-world asset.

For example, in FIG. 4, the object avatar 408 (shown as a handbag avatar, which may corresponding to a type of luxury brand handbag) represents a duality asset. This means, for example, that there is a one-to-one correspondence between the object avatar 408 and the physical real-world asset 410 (an actual luxury brand-manufactured physical bag).

(c) Validation of ownership of duality assets: In some examples, it is further desirable for there to be a mechanism to prove simultaneous ownership of both an object avatar in a metaverse and its matching real-world physical asset. For example, if in the metaverse the user 400 claims ownership of a duality asset (represented by object avatar 408), then it is desirable for user 400 to also be able to prove that they own the physical assets/goods in the real world.

(d) Movability of user avatars and object avatars across metaverses: In some examples, it is desirable for there to be a mechanism for a user to move/copy their legitimate user avatars and the object avatars (which corresponds to assets they own) from one metaverse to another.

### Cross-Metaverse Double-Spend Scenarios

In many metaverse networks, users have the freedom to create their own user avatars within a metaverse. Furthermore, a user may choose to display the object avatars (e.g., of assets the users legally own) in different metaverses simultaneously. The action of displaying authentic object avatars in some linked manner to user avatars is natural and represents one common feature of metaverse worlds. However, issues can arise when the legal owner of a singularity asset or duality asset seeks to sell or trade this asset in the metaverse.

More specifically, when an asset (e.g., represented by object avatar 408) in two metaverses is being sold/traded in one metaverse, then as soon as the ownership transfer is completed, in some examples, the ownership-link between the object avatar and the previous owner (i.e., their user-avatar) is to be severed or broken. This is to prevent the previous owner from continuing to claim ownership of an item which they have sold. Furthermore, if the asset is a duality asset, then the real-world asset is also to be synchronously transferred to the new owner. This can be referred to, for example, as a “cross-metaverse double-spend scenario.”

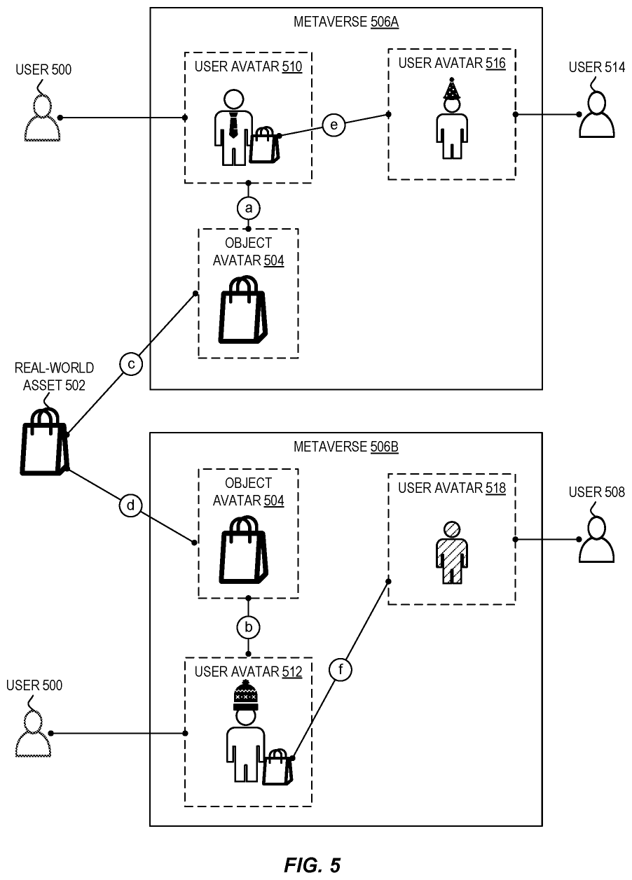

FIG. 5 is a diagram illustrating a cross-metaverse double-spend scenario in which a duality-asset is sold twice in different metaverses according to some examples. In FIG. 5, a user 500 (e.g., a human user) owns a duality asset, consisting of the physical real-world asset 502 (e.g., a branded handbag) and its matching object avatar 504. The object avatar 504 is shown to exist in both a metaverse 506A and a metaverse 506B simultaneously (illustrated by lines the labeled “a” and labeled “b”, respectively, showing its use in connection with each of user avatar 510 and user avatar 512 in the respective metaverses), although both instances of the object avatar pertain to the same single physical real-world asset 502 (illustrated by lines the labeled “c” and labeled “d”, respectively).

In FIG. 5, a user 500 employs user avatar 510 in metaverse 506A, while the same user 500 employs a different user avatar 512 in metaverse 506B. In both cases, the user embeds (or otherwise couples) the object avatar 504 within both of the user avatars, denoting the claim that the user 500 owns the duality asset. Furthermore, in FIG. 5, the user 500 may offer the sale of the duality-asset to both a user 514 (employing user avatar 516 in metaverse 506A), where this first offer for sale is represented by the line labeled “e”, and to user 508 (employing user avatar 518 in metaverse 506B), where this second offer for sale is represented by the line labeled “f”. That is, the user 500 is offering the sale of the duality-asset in two (2) distinct metaverses simultaneously. As described herein, the asset consistency management system 100 can be used to alleviate issues caused by these and other scenarios.

### Asset Definitions and Instances

In some examples, a metaverse asset is defined by a metaverse asset definition authority (or “ADA”), who creates either a singularity asset definition (or “SAD”) data structure (e.g., a file) or a duality asset definition (or “DAD”) data structure. Instances of an asset are then produced by an asset issuer entity based on the singularity asset definition data structure (for singularity assets) or duality asset definition data structure (for duality assets). The asset definition authority and the issuer entity can be the same legal entity or different entities.

### Singularity Asset Definition (or “SAD”)

In some examples, a metaverse singularity asset definition is used to permit an authority (including manufacturers and brand owners) to define what constitutes an asset in one or more metaverse(s), the real-world, or both. A singularity asset definition data structure is then used as the basis for an asset issuer to declare an instance of an asset that conforms to the definition found in a singularity asset definition data structure. A similar arrangement is used for composite singularity assets (i.e., metaverse assets that consists of multiple parts).

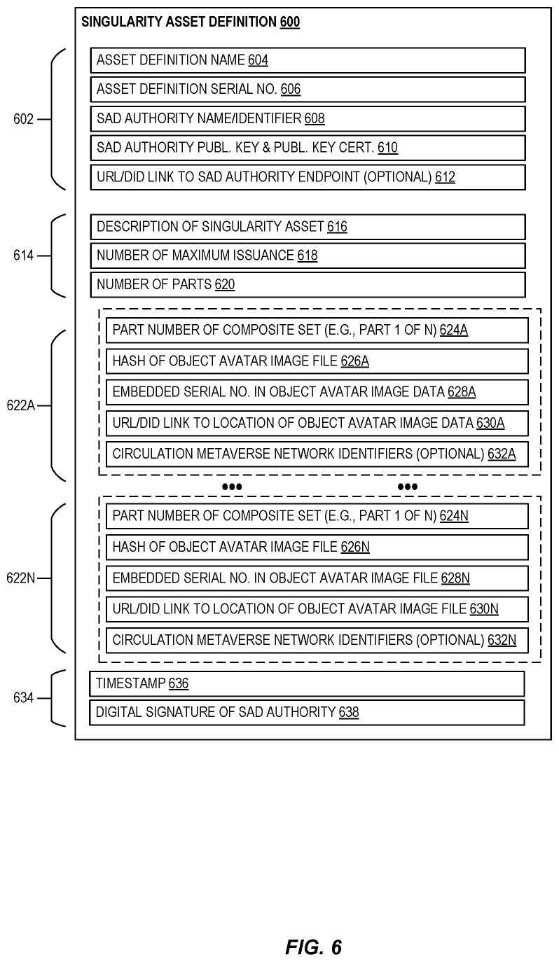

FIG. 6 is a diagram illustrating a summary of a metaverse singularity asset definition data structure supporting composite assets according to some examples. In some examples, a singularity asset definition 600 (e.g., as stored in a file or other data structure) consists of some or all the following:

Authority information section 602: In some examples, the authority information section 602 indicates the entity who defined the metaverse virtual asset with attributes listed in the definition file. For example, the authority information section 602 can include an asset definition name 604, an asset definition serial number 606, a singularity asset definition authority name or identifier 608, a singularity asset definition authority public key and public key certificate 610, and a Uniform Resource Locator (URL)/decentralized identifier (DID) link to singularity asset definition authority endpoint (optional) 612.

Asset description section 614: In some examples, the asset description section contains a description of the singularity asset 616, the number of permitted instances of the asset 618, and an indicator indicating whether the SAD definition encompasses only one metaverse asset or multiple metaverse assets (e.g., a number of parts 620, where if the number is greater than one then the asset represents a composite asset).

Asset information section 622A, . . . , 622N: In some examples, the asset information section contains information regarding one (or multiple) of the metaverse asset definitions. For example, in the case of a composite asset, the definition 600 can include N distinct metaverse singularity assets. As shown, the asset information section can optionally include a part number of a composite set 624A, . . . , 624N, a hash of the object avatar image data 626A, . . . , 626N, an embedded serial no. in the object avatar image data 628A, . . . , 628N, a URL/DID link to a location of the object avatar image data 630A, . . . , 630N, and circulation metaverse network identifiers (optional) 632A, . . . , 632N.

Timestamp and digital signature section 634: This part contains the timestamp/date 636 and the digital signature of the singularity asset definition authority 638 that defined the metaverse as set.

Note that the singularity asset definition is merely the definition of the asset. In some examples, the actual asset itself is contained in an asset instance declaration file generated by a legally recognized issuer of the asset, and the ownership of an instance is created using an asset ownership token, as described in more detail hereinafter.

### Duality Asset Definition (or “DAD”)

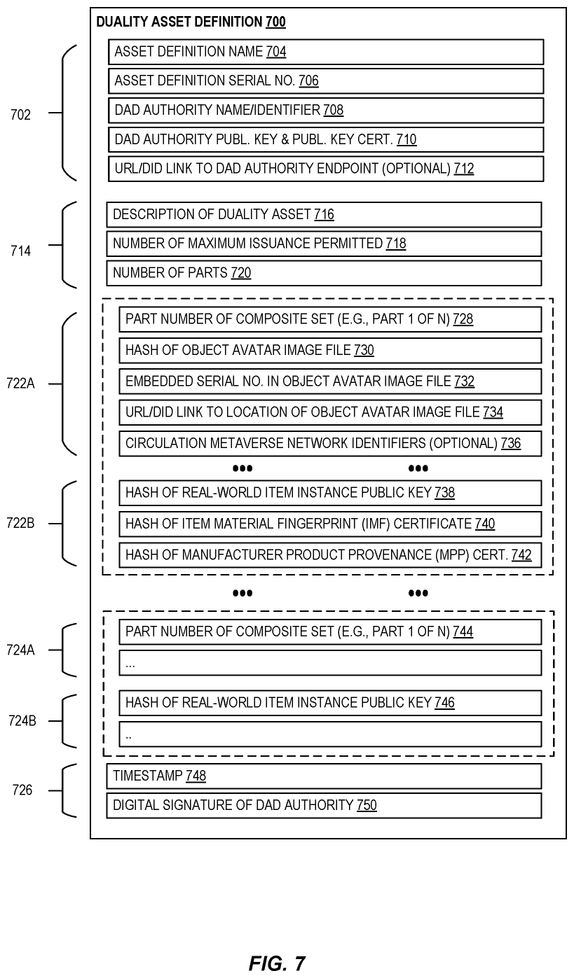

In some examples, a duality asset definition (or “DAD”) file is similar in construction with the singularity asset definition except that each of the possible N metaverse assets consists of two parts: the metaverse digital asset and the real-world asset that are bound together (e.g., illustrated as section 722A and section 722B, respectively, in the example duality asset definition 700. In the case of a composite duality assets, there are several (i.e., N) of these pairs (e.g., where additional pair(s) are shown as section 724A and section 724B). FIG. 7 is a diagram illustrating a summary of the metaverse duality asset definition data structure supporting N composite assets according to some examples.

The duality similarly includes an authority information section 702, including an asset definition name 704, an asset definition serial number 706, a duality asset definition authority name or identifier 708, a duality asset definition authority public key and public key certificate 710, and a Uniform Resource Locator (URL)/decentralized identifier (DID) link to singularity asset definition authority endpoint (optional) 712.

In some examples, the asset description section 714 contains a description of the duality asset 716, the number of permitted instances of the asset 718, and an indicator indicating whether the definition encompasses only one metaverse asset or multiple metaverse assets (e.g., a number of parts 720, where if the number is greater than one then it represents a composite asset).

In some examples, a metaverse asset section (e.g., 722A) includes a part number of a composite sect 728 (if the asset is a composite asset), a hash of the object avatar images file 730, an embedded serial number in the object avatar image file 732, a URL/DID link to a location of the object avatar image file 734, and a circulation metaverse network identifier 736 (optional).

In some examples, a real-world asset portion 722B includes a hash of the real-world item instance public key 738, a hash of an item material fingerprint (or “IMF”) certificate 740, and a hash of a manufacturer product provenance (or “MPP”) certificate 742. As shown, the additional pairs 724A, 724B can include similar fields such as a part number of a composite set 744, a hash of the real-world item instance public key 746, and other fields not shown. The duality asset definition 700 further includes a timestamp and digital signature section 726 including the timestamp 748 and the digital signature of the duality asset definition authority 750.

### Registration of Asset Instances

In order to produce an asset that can traded and owned within the asset management consistency system 100, in some examples, a legal asset issuer declares or registers the existence of the asset onto a decentralized digital asset trading ledger (e.g., one of decentralized ledgers 108) within the asset consistency management system 100, as described hereinafter. An asset instance is digitally signed by the issuer.

Once recorded on the decentralized digital asset trading ledger, the asset instance remains on the ledger until such time it is destroyed. Since it is the issuer who declared the existence of the asset in the trading ledger, it is also the issuer who has the power to declare the non-existence (or destruction) of a previously declared asset. This is relevant, for example, for duality assets where the real-world asset (e.g., a physical handbag) no longer exists (e.g., the asset is destroyed in the physical world).

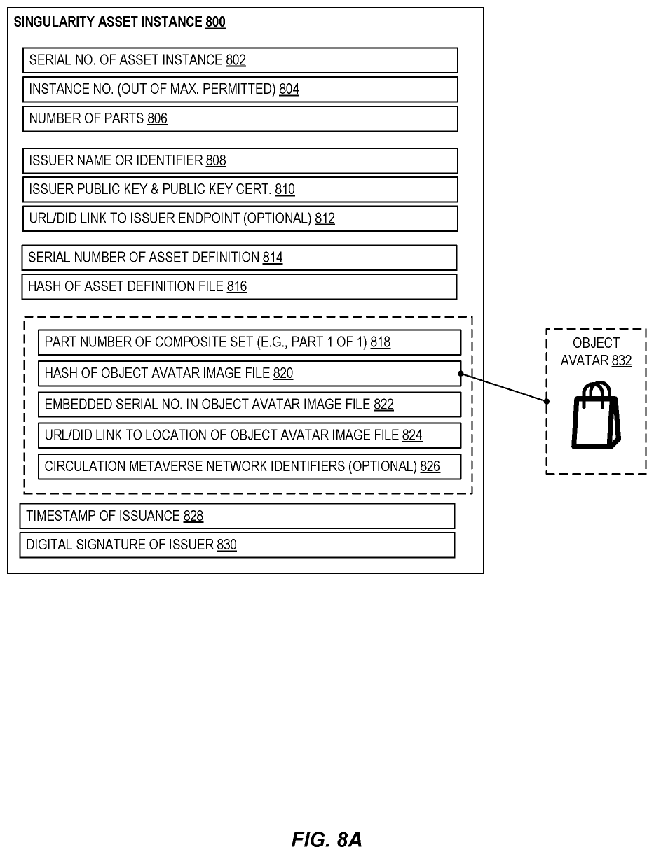

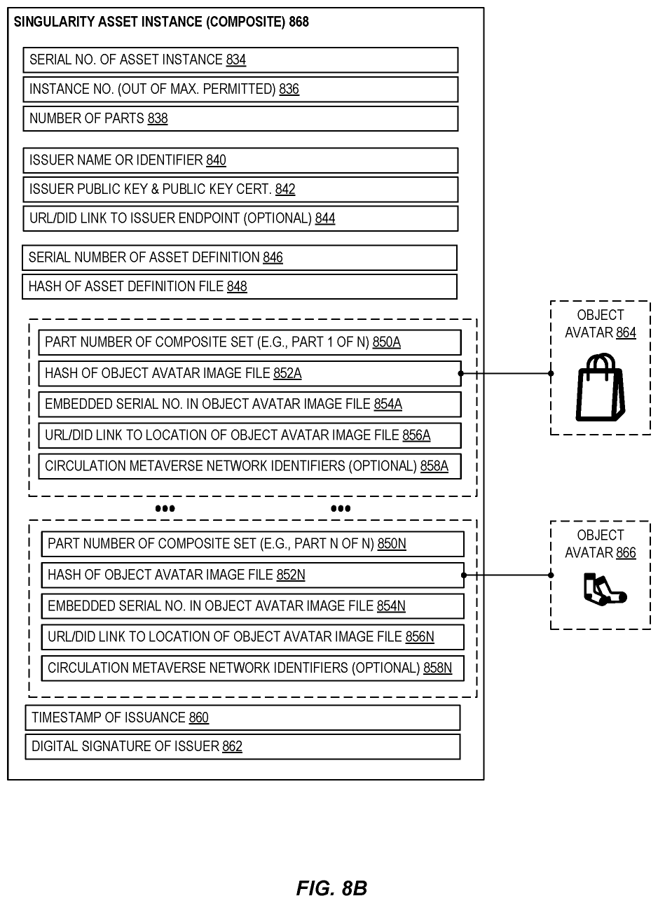

FIG. 8A is a diagram illustrating an example of a singularity asset instance including a single metaverse asset according to some examples. FIG. 8B is a diagram illustrating an example of a singularity asset instance consisting of a composite of two or more metaverse assets according to some examples. In FIG. 8A, the singularity asset instance 800 includes data indicating, for example, a serial number of the asset instance 802, an instance number 804 (e.g., out of a maximum number of instances permitted), a number of parts 806, an issuer name or identifier 808, an issuer public key and public key certificate 810, a URL/DID link to issuer endpoint 812 (optional), a serial number of asset definition 814, and a hash of the corresponding asset definition file 816.

In some examples, a singularity asset instance 800 can further include a part number of a composite set 818 (e.g., in the example of a composite asset), a hash of corresponding object avatar image data 820, an embedded serial number in the object avatar image data 822, a URL/DID link to a location of object avatar image data 824, and a circulation metaverse network identifier 826 (optional). The singularity asset instance 800 further includes a timestamp 828 and a digital signature of the issuer 830. As shown, the singularity asset instance 800 can correspond to a specific instance of an object avatar 832, which can exist in a metaverse.

In some examples, the ownership of a newly declared asset is assigned (i.e., self-assigned) to the issuer using an asset ownership token in the decentralized trading ledger of the asset consistency management system 100. When the issuer completes the declaration (registration) of an asset to the decentralized trading ledger, in some examples, it also declares it on a metaverse tracking ledger.

As indicated, FIG. 8B illustrates an example of a singularity asset instance 868 representing a composite of two or more metaverse assets. As shown, the instance 868 includes a serial number of the asset instance 834, an instance number 836 (out of a maximum permitted number of instances), and a number of parts 838 of the composite asset. In some examples, a singularity asset instance 868 further includes an issuer name or identifier 840, an issuer public key & public key certificate 842, a URL/DID link to an issuer endpoint 844 (optional), a serial number of the asset definition 846, and a hash of the corresponding asset definition file 848. For each asset of the composite set, in some examples, a singularity asset instance 868 includes a part number of the composite set (e.g., part number of a composite set 850A, . . . , part number of a composite set 850N), a hash of the object avatar image file (e.g., hash of the object avatar image file 852A, . . . , hash of the object avatar image file 852N), an embedded serial number in the object avatar image file (e.g., the embedded serial number in the object avatar image file 854A, . . . , embedded serial number in the object avatar image file 854N), a URL/DID link to a location of the object avatar image file (e.g., URL/DID link to a location of the object avatar image file 856A, . . . , URL/DID link to a location of the object avatar image file 856N), and circulation metaverse network identifier(s) (optional) (e.g., circulation metaverse network identifier(s) 858A, . . . , circulation metaverse network identifier(s) 858N). The instance 868 further includes a timestamp of issuance 860 and a digital signature of the issuer 862. As shown the hash of the object avatar image files relate to example object avatar 864 and object avatar 866.

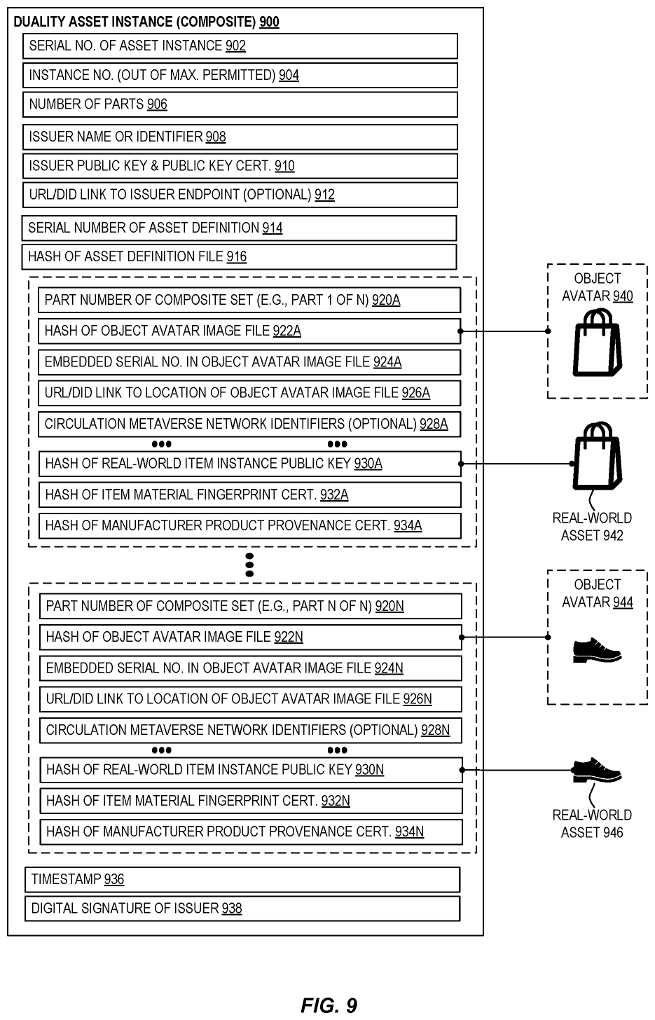

FIG. 9 is a diagram illustrating an example of a duality asset instance, which is a composite of two pairs (dualities) of assets, according to some examples. As shown, the duality asset instance 900 includes a serial number of the asset instance 902, an instance number 904 (out of a maximum permitted number of instances), a number of parts 906, an issuer name or identifier 908, an issuer public key & public key certificate 910, a URL/DID link to an issuer endpoint 912 (optional), a serial number of the asset definition 914, and a hash of the corresponding asset definition file 916. The duality asset instance 900 further includes N sets of definition pairs for the N duality asset composite parts (e.g., represented by object avatar 940 and a corresponding real-world asset 942, and an object avatar 944 and a corresponding real-world asset 946).

As shown, each composite asset definition can include a metaverse asset portion and a real-world asset portion, where the metaverse asset portion includes a part number of the composite set 920A, . . . , 920N, a hash of the avatar image file 922A, . . . , 922N, an embedded serial number in the object avatar image file 924A, . . . , 924N, a URL/DID link to a location of the object avatar image file 926A, . . . , 926N, and a circulation metaverse network identifier(s) 928A, . . . , 928N (optional). The real-world asset portion can include a hash of a real-world item instance public key 930A, . . . , 930N (where the real-world asset can include embedded hardware storing a corresponding public/private key pair), a hash of an item material fingerprint certificate 932A, . . . , 932N, and a hash of a manufacturer product provenance certificate 934A, . . . , 934N. The duality asset instance 900 further includes a timestamp 936 (e.g., indicating when the instance was created) and a digital signature of the issuer 938.

### The Multiverse Asset Consistency Management System

In some examples, to ensure that: (i) a person (a person avatar) who bears or wields an object avatar within a metaverse is truly the owner of the corresponding asset, and (ii) to permit the person (or user avatar) to sell, trade, or lend the object avatar within one metaverse or across multiple metaverses, the asset consistency management system 100 is provided to ensure the authenticity and correctness of state of objects (object avatars). In some examples, some or all components of the asset consistency management system 100 can be implemented as software-based applications, services, or other computing-based resources running on cloud-based resources, on-premises computing resources, etc. The correctness of the state of objects can be particularly relevant for certain scarce goods (e.g., luxury products) whose product authenticity (in both the metaverse and in the real-world) is highly desirable, and where it is highly desirable for the ownership to be verifiable by any party (online and offline).

In some examples, the asset consistency management system 100 consists of several decentralized ledgers, smart contracts, and protocols that together seek to ensure consistency of the state of persons (represented by user-avatars), objects (represented by object-avatars) and venues (represented by venue-avatars). As indicated above, these ledgers, smart contracts, and protocols can each be implemented using various types of software-based applications, services, or other computing resources running on cloud-based resources, on-premises computing resources, or combinations thereof.

### Ledger Subsystems of the Asset Consistency Management System

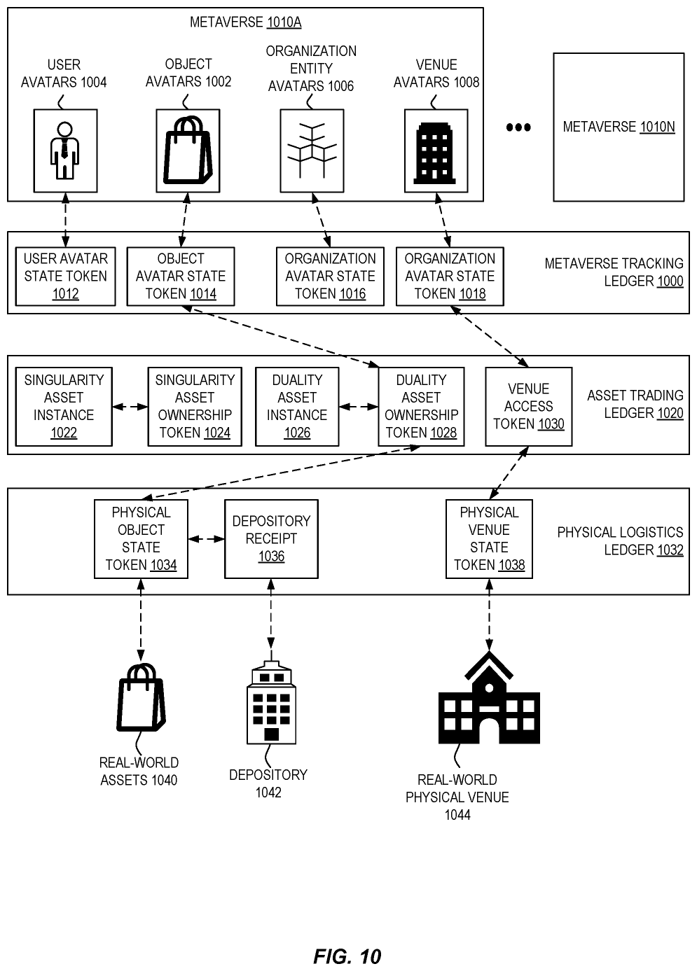

According to examples described herein, an asset consistency management system 100 uses a waterfall ledger architecture, which includes some or all the following types of decentralized ledger subsystems. FIG. 10 is a diagram illustrating a summary of a waterfall ledger architecture according to some examples.

Metaverse tracking ledger (or “tracking ledger”): In some examples, a metaverse tracking ledger 1000 is a decentralized ledger subsystem of the asset consistency management system 100 used to record in which metaverses a given object avatar (e.g., from object avatars 1002) has been displayed by which user avatar (e.g., from user avatars 1004). This ledger, e.g., allows a brand owner to detect whether one of its products (e.g., an object avatar 1002) has been displayed and offered for sale in an authorized or authorized manner. It also permits organizations to manage organization entity avatars (e.g., organization entity avatars 1006), and further permits venue owners to create unique metaverse venues (e.g., represented by venue avatars 1008). As shown, these various types of assets can be present across any number of distinct metaverses (e.g., metaverse 1010A, metaverse 1010N). As shown, these assets can be managed in part by various types of tokens or other data structures stored on the metaverse tracking ledger 1000 such as, e.g., user avatar state tokens (e.g., such as a user avatar state token 1012 to track a user avatar 1004), object avatar state tokens (e.g., such as an object avatar state token 1014 to track an object avatar 1002), organization avatar state tokens (e.g., such as an object avatar state token 1014 to track an organization entity avatar 1006), organization avatar state tokens (e.g., such as an organization avatar state token 1016 to track a venue avatar 1008), and the like.

Asset trading ledger (or “trading ledger”): In some examples, an asset trading ledger 1020 is a decentralized ledger subsystem of the asset consistency management system 100 used to carry out the exchange of ownership of singularity assets and duality assets in such a manner that double-spends (within one metaverse or across multiple metaverses) can be detected and prevented. As shown, an asset trading ledger 1020 can manage such transactions via tokens or other data structures including, e.g., singularity asset instances (e.g., such as singularity asset instance 1022 token), singularity asset ownership tokens (e.g., such as singularity asset ownership token 1024), duality asset instances (e.g., such as a duality asset instance 1026), duality asset ownership tokens (e.g., such as a duality asset ownership token 1028), venue access tokens (e.g., such as a venue access token 1030), and the like.

Physical Logistics Tracking Ledger (or “Logistics Ledger”): In some examples, a physical logistics ledger 1032 is a decentralized ledger subsystem of the asset consistency management system 100 used to record the physical location/logistics of a real-world asset and the entity controlling it (e.g., physically holding). It is also used to record the state of a physical venue-space (e.g., who owns it; who leased it; etc.). As shown, the physical logistics ledger can include tokens or other data structures including, for example, physical object state tokens (e.g., a physical object state token 1034 corresponding to a real-world asset 1040, and possibly to a duality asset ownership token 1028 or other token on an asset trading ledger 1020), depository receipts (e.g., depository receipt 1036 corresponding to a depository 1042), physical venue state tokens (e.g., a physical venue state token 1038 corresponding to a real-world physical venue 1044, and optionally to one or more venue access tokens 1030 via an organization avatar state token 1018).

The functions pertaining to the three decentralized ledgers can be implemented as distinct subsystems or, in other examples, the subsystems can be implemented as one system.

### Overview of the Types of Assets and Tokens

In some examples, the three decentralized ledger subsystems (e.g., a metaverse tracking ledger 1000, asset trading ledger 1020, and physical logistics ledger 1032) are used to maintain certain types of assets and tokens.

Asset instances and their ownership tokens: In some examples, a given singularity (or duality) asset instance can be recorded on the asset trading ledger 1020 by its asset issuer (which can be, for example, the brand owner or manufacturer) as shown by singularity asset instance 1022 and singularity asset ownership token 1024, and by the duality asset instance 1026 and duality asset ownership token 1028, in FIG. 10. If there are N instances of an asset, then N unique singularity (or duality) assets instances are recorded by the asset issuer. As indicated, the assets can be recorded on the asset trading ledger 1020 using APIs or other interfaces provided by the asset consistency management system 100.

It is noted that a singularity (or duality) asset instance recorded on the asset trading ledger 1020 is a means by which the issuer declares that the asset exists on the asset trading ledger 1020. An asset instance generally does not by itself confer any ownership. In some examples, asset ownership tokens are a mechanism used to indicate the ownership of asset instances by a user or entity. Thus, while there is generally only one singularity (or duality) asset instance declared on the trading ledger, there may be multiple asset ownership tokens (for that asset instance) over time on the trading ledger. For example, each time the ownership changes, a new asset ownership token is created on the asset trading ledger 1020.

User avatar state tokens: In some examples, to track the entry (or departure) of users into (or out of) metaverses, a user avatar state token (e.g., a user avatar state token 1012) is maintained on the metaverse tracking ledger 1000. A user avatar state token, for example, can denote the legal ownership of a corresponding user avatar (e.g., a user avatar 1004), consisting of the graphical image file (e.g., a JPEG formatted file) or other digital representation of the avatar image. In some examples, for each metaverse that a same user avatar is present, a separate user avatar state token is created on the metaverse tracking ledger 1000.

Object avatar state token: In some examples, to track the entry (or departure) of (optionally branded) objects avatars (e.g., object avatars 1002) into (or out of) metaverses, a corresponding object avatar state token (e.g., an object avatar state token 1014) is maintained on the metaverse tracking ledger 1000.

In some examples, a “branded” object avatar is a type of object avatar in that it is associated with a brand owner who is the trademark owner or otherwise associated with a brand, logo, or other intellectual property associated with the object avatar. Thus, a branded object avatar is created by the brand owner or manufacturer and constitutes the asset itself.

Physical object state tokens: In some examples, to track the physical location or possession of a real-world object (e.g., a real-world asset 1040) that is the physical asset (e.g., luxury goods, artwork, etc.), a physical object state token (e.g., a physical object state token 1034) is maintained on the physical logistics ledger 1032. When the physical good is in the hands of a legally recognized depository entity (e.g., a depository 1042), in some examples, a depository receipt (e.g., a depository receipt 1036) is also maintained on the physical logistics ledger 1032.

### Types of Keys for Users and Asset Holders

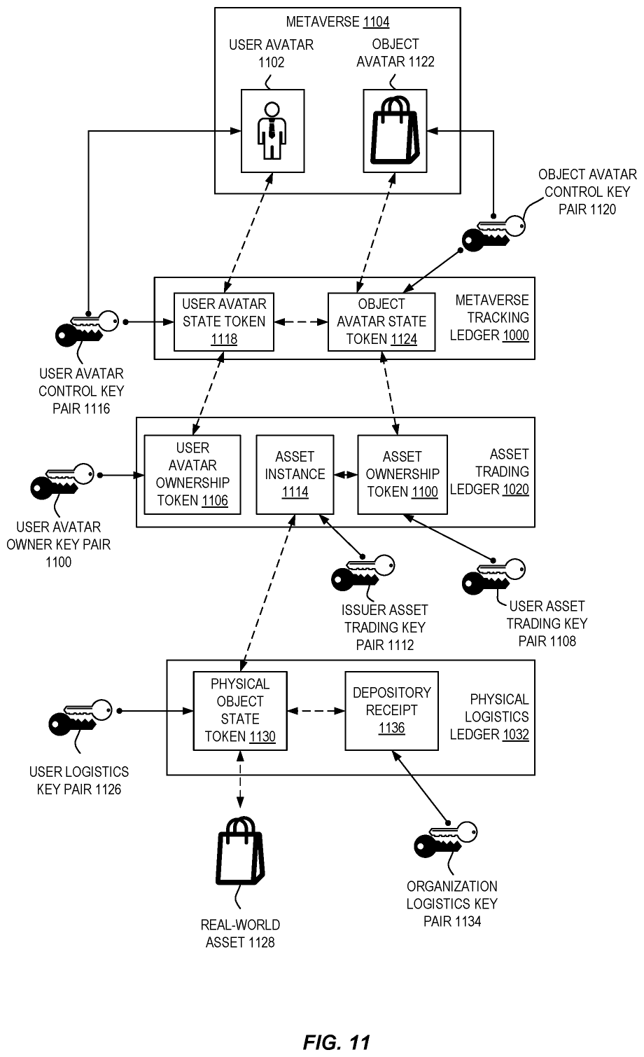

The asset consistency management system 100 ledger subsystems together employ a number of data structures (including, e.g., tokens) and cryptographic keys in order to achieve consistency among metaverse assets, real-world assets, and their ownership. FIG. 11 is a diagram illustrating an overview of the type of keys used in an asset consistency management system according to some examples. The following provides a summary of the categories of the public/private key-pairs, their purpose, their holders and the ledgers where they are utilized in some examples.

Keys utilized on the asset trading ledger 1020: In some examples, the keys used on the asset trading ledger 1020 generally pertain to proof of ownerships of assets (including both singularity and duality assets). Example types of key pairs are as follows:

User avatar ownership key pair: In some examples, a user avatar key pair (e.g., a user avatar owner key pair 1100) is used by the owner of a user avatar to prove ownership of a user avatar (e.g., a user avatar 1102 currently used in a metaverse 1104). For example, it can be utilized when a current owner/controller of a user avatar seeks to sell the avatar to another user. As shown, a user avatar ownership token 1106 is digitally signed using a user avatar owner key pair 1100. In some examples, sale of a user avatar by a user does not imply that all asset instances belonging to the user are also sold.

User asset trading key pair: In some examples, a user asset trading key pair (e.g., a user asset trading key pair 1108) is used by a user (who owns a user avatar) to buy, sell, or trade asset instances on the asset trading ledger 1020. As shown, a user asset trading key pair 1108 can be used to signed asset ownership tokens (e.g., an asset ownership token 1110).

Issuer asset trading key pair: In some examples, an issuer asset trading key pair (e.g., an issuer asset trading key pair 1112) is used by the issuer of a digital asset (e.g., brand owners) to perform the registration of asset instances onto the asset trading ledger (e.g., an asset instance 1114). In some examples, it is also used to assign (e.g., sell) new ownership of an asset instance to a user.

Keys utilized on the metaverse tracking ledger 1000 can include:

User avatar control key pair: In some examples, a user avatar control key pair (e.g., a user avatar control key pair 1116) is used by the owner of a user avatar (e.g., a user avatar 1102) to record the state of the user avatar (to the metaverse tracking ledger 1000) when the user avatar has been deployed in one or more metaverses by its owner. As shown, a user avatar control key pair can be used to digitally sign, e.g., a user avatar state token 1118 stored on the metaverse tracking ledger 1000.

Object avatar control key pair: In some examples, an object avatar control key pair (e.g., an object avatar control key pair 1120) is used by the owner of an object avatar to record the state of an object avatar (the state of an object avatar 1122, to the metaverse tracking ledger 1000, via an object avatar state token 1124) when the object avatar has been deployed in one or more metaverses by its owner.

Note that in the case of both types of metaverse assets, in some examples, the legal ownership of a singularity asset or duality asset means that the owner holds the control keypair of the object avatar that visually/graphically represents the object in the metaverse world.

Organization avatar control key-pair: In some examples, an organization avatar control key pair (not shown) is utilized by an organization (e.g., a brand owner) to prove that it controls a given organization avatar in the metaverse. This key pair is unique for each (organization avatar, metaverse) pair. Thus, if an organization possesses multiple organization-avatars across many metaverses, in some examples, the organization creates a unique key-pair for each of these organization-avatars/metaverses.

In some examples, keys utilized on the physical logistics ledger 1032 can include:

User logistics key pair: In some examples, a user logistics key pair 1126 is used by a user to record assertions (onto the physical logistics ledger 1032) regarding the physical state/location of a real-world asset (e.g., a real-world asset 1128) that is bound to a metaverse duality asset (e.g., bound, via a physical object state token 1130, to an asset instance 1114).

Organization logistics key pair: In some examples, an organization logistics key pair 1134 is used by an organization (e.g., a brand shop, depository, etc.) to record a receipt or confirmation (e.g., a depository receipt 1136, onto the physical logistics ledger 1032) regarding a user's claim about the physical state/location of a real-world asset (e.g., a real-world asset 1128) that is bound to a metaverse duality asset. For example, an organization in this context can be a legal depository of assets or a brand shop that sells brand products and acts as a temporary depository or escrow when the physical goods is in the state of being available for trade in the metaverse via its duality asset. Note that the set of keys held by a user may be different from the set of keys held by a brand owner or other entities.

### Key Arrangement for Event Owners and Venue Owners

Metaverse events can be organized by an entity referred to as an “event owner” (or “event organizer”). For metaverse events (singularity events or duality events), the event can be graphically represented in the metaverse using an event avatar.

The venue in the metaverse where an event occurs is graphically represented in the metaverse using a venue-avatar.

Event avatar control key pair: In some examples, an event avatar control key pair is used by an event organizer (e.g., a brand owner) to prove that it controls a given event avatar in a metaverse. This key pair is unique for each (event avatar, metaverse) pair. Thus, if an event organizer runs multiple events across many metaverses, in some examples, an event organizer uses the asset consistency management system 100 to create a unique control keypair for each of these events.

Venue avatar control key pair: In some examples, a venue avatar control key pair is used by a venue owner to prove that it controls a given venue avatar in a metaverse. This key pair is unique for each (venue avatar, metaverse) pair. Thus, if an entity owns multiple venues across many metaverses, in some examples, the entity creates a unique control key pair for each of these venues.

Ticket avatar control keypair: In some examples, a ticket avatar control key pair is used by a ticket asset owner to prove that it controls a given ticket-avatar in the metaverse. Thus, for example, if a user U1 holds the ticket asset ownership token on the asset trading ledger 1020, in some examples, that user is also the holder of the ticket-avatar and its associated control keypair.

### Metaverse Avatars and Tokens

As indicated, in some examples, a metaverse tracking ledger 1000 is used to register and track the avatars employed in different metaverses to ensure that claims of ownership of object avatars (including e.g., luxury branded goods) in the metaverse can be validated. It is noted that users are generally free to create their own avatars and to participate in any metaverse. Furthermore, users can display (or “wield,” or “show off”) the metaverse assets which they own. This is typically performed by the user (asset owner) displaying in a linked manner the object avatars that visually represent the asset in question (either digital singularity assets or duality assets). This may be particularly relevant for branded object avatars—that is, object avatars created by brand owners and manufacturers—because some unauthenticated users in a metaverse may attempt to wield counterfeit branded object avatars, thereby negatively the economic-value of the brand.

When a user in a metaverse (represented by their user avatar) wields a branded object avatar, in some examples, it is desirable for an associated brand owner to have the technical ability to challenge the user at any time to prove that the user is the legitimate owner of the asset represented graphically in that metaverse by the branded object avatar. Similarly, it is desirable for only a venue owner to have the ability to create a branded venue-avatar within a given metaverse.

### Registration of Asset Instances and Assigning/Registering First Ownership

In order for an asset instance to be available for trade (e.g., purchase) on the asset trading ledger 1020 of the asset consistency management system 100, in some examples, the asset issuer first uses the asset consistency management system 100 to record the asset instance onto the asset trading ledger 1020 (e.g., using a web-based console, API, or other interface provided by the asset consistency management system 100). Example data structures used to represent an asset instance on the trading ledger is shown in FIG. 8A and FIG. 8B for singularity assets and in FIG. 9 for duality-assets. The following summarizes actions involved in making available asset instances to users.

Registering asset instance: In some examples, an issuer registers an asset instance by using the asset consistency management system 100 to record a signed asset instance data structure (singularity or duality) via a write-transaction to the asset trading ledger. The recording of a signed asset instance data structure can be accomplished using a web-based console, standalone application, API, or other interface provided by an asset consistency management system 100. If there are multiple instances (e.g., M instances) of an asset, in some examples, the issuer uses the asset consistency management system 100 to register M separate tokens or other data structures to the asset trading ledger 1020 using the asset consistency management system 100. The issuer utilizes its issuer asset trading key pair to perform this task, e.g., as described herein with reference to FIG. 11, where the issuer asset trading key pair is used to digitally sign the asset instance. As indicated, the management of the key pairs, asset instance data structure creation, digital signing of the asset instance, can be facilitated using one or more services or applications provided by the asset consistency management system 100.

Assigning ownership of each instance: In some examples, for each registered asset instance (e.g., for each of M instances), the issuer uses the asset consistency management system 100 to record, to the asset trading ledger 1020, a signed asset ownership token (i.e., M tokens), in which the asset consistency management system 100 uses the issuer's own public key as the owner public key. This denotes, for example, that the issuer initially owns the asset. The issuer employs its asset trading key pair to digitally sign the asset instance registration and ownership token.

In some examples, the asset instance registration record is a declaration of the existence of the asset. As such, the record on the asset trading ledger 1020 persists into the future. In contrast, the ownership of the instance of the asset can change hands at any time. In some examples, this is performed by way of a current owner selling the ownership token to a new party or otherwise causing a new ownership token to be created.

### Asset Ownership Tokens for Asset Instances

In some examples, an asset ownership token data structure is used on the asset trading ledger 1020 to denote the ownership of a given metaverse asset instance (either singularity assets or duality assets) based on an asset definition (e.g., as illustrated in FIG. 6 or FIG. 7). In some examples, there is a one-to-one correspondence between an asset instance token and its ownership token on the asset trading ledger 1020. Thus, if the asset issuer uses the asset consistency management system 100 to register M instances of the asset to the asset trading ledger 1020, then for each of the M instances, there can only be M ownership tokens that are valid at any time. At any moment in time, in some examples, the most recent created ownership token (for an asset instance) on the trading ledger is considered by the asset consistency management system 100 to be the valid ownership token.

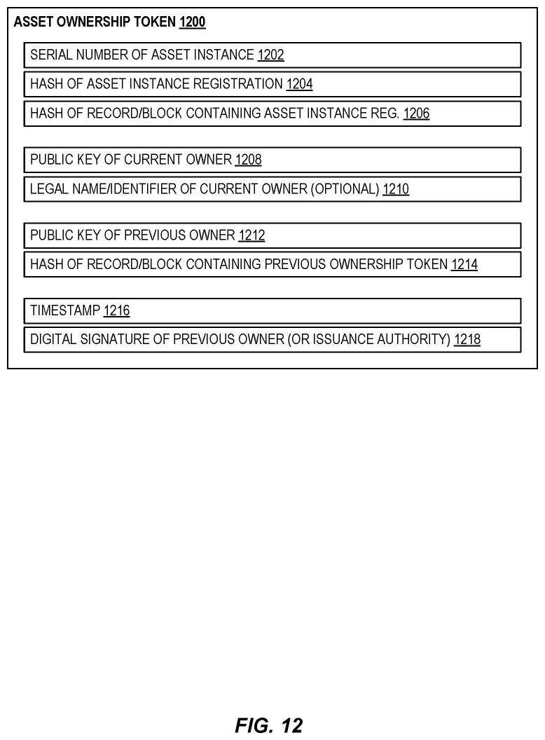

FIG. 12 is a diagram illustrating an overview of the asset ownership token data structure for a given asset instance on an asset trading ledger according to some examples. As shown, an asset ownership token 1200 created by an asset consistency management system 100 can include data fields including, for example, a serial number of the asset instance 1202, a hash of the asset instance registration 1204, and a hash or the record/block containing the asset instance registration 1206. The asset ownership token 1200 can further include a public key of the current owner 1208 (e.g., initially the public key of the asset issuer) and, optionally, a legal name/identifier of the current owner 1210. The asset ownership token 1200 can further include a public key of the previous owner 1212, a hash of the record/block containing a previous ownership token 1214, a timestamp 1216, and a digital signature of a previous owner (or issuance authority) 1218. Additional details related to some of these fields is included below:

Serial number of the asset instance declaration: In some examples, the serial number of the asset instance 1202 is the serial number found in the asset instance registration (shown in FIG. 8A and FIG. 8B for singularity-assets and in FIG. 9 for duality-assets).

Hash of record/block containing the asset instance registration: In some examples, the hash of the asset instance registration 1206 is a hash of the committed record/block in the asset trading ledger 1020 that carries the confirmed asset instance registration transaction.

Hash of record/block containing the previous ownership token: In some examples, a hash of the record/block containing a previous ownership token 1214 is the committed record/block in the asset trading ledger 1020 that carries the previous confirmed ownership token transaction. If the asset has no previous owners, such as a newly produced asset by the asset issuer, this field can be blank or contain a null value.

Public key of the current owner: In some examples, the public key of the current owner 1208 is the public key of the current owner of the asset instance.

Timestamp and digital signature of previous owner: In some examples, the timestamp 1216 and digital signature of a previous owner (or issuance authority) 1218 is the digital signature that assigns legal ownership to the holder of the public key stated in the token (i.e., the public key of the current owner).

An ownership token can be bought or sold (or traded) via the asset trading ledger 1020. Ownership can be changed by the current owner of a token by using the asset consistency management system 100 to issue a SELL-Transaction (SELL-TX) on the asset trading ledger 1020 and inputting the public key (or other address) of the recipient as one of the parameters of the SELL-Transaction. In some examples, a successful (confirmed) SELL-TX command on the trading ledger results in the addition (appending) of a new asset ownership token on the asset trading ledger 1020, in which the public key of the recipient is recorded in the current owner field.

In some examples, the chain of hash-linked asset ownership tokens provides a history of the legal ownership of an instance of a given metaverse asset, starting from the first asset ownership token which was assigned by its issuer to itself. The ownership token for ticket asset instances pertaining to a metaverse duality event is described elsewhere herein.

### User Avar Ownership Tokens

Within a metaverse, users have the freedom to create or design their own user avatars (e.g., based on images or other graphical representation of themselves) and, in some examples, the virtualization system implementing the metaverse ensures that each user avatar has sufficient visible uniqueness to prevent confusion by other users.

In some examples, the asset consistency management system 100 assists users by permitting a human user to claim ownership of their avatar (e.g., a graphical image file or other digital representation that can be used to display the avatar) by way of recording a user avatar ownership token onto the asset trading ledger 1020. The token asserts that the user who holds the private key (e.g., on a computing device in control of the user) of the user avatar owner key pair is the owner of the avatar.

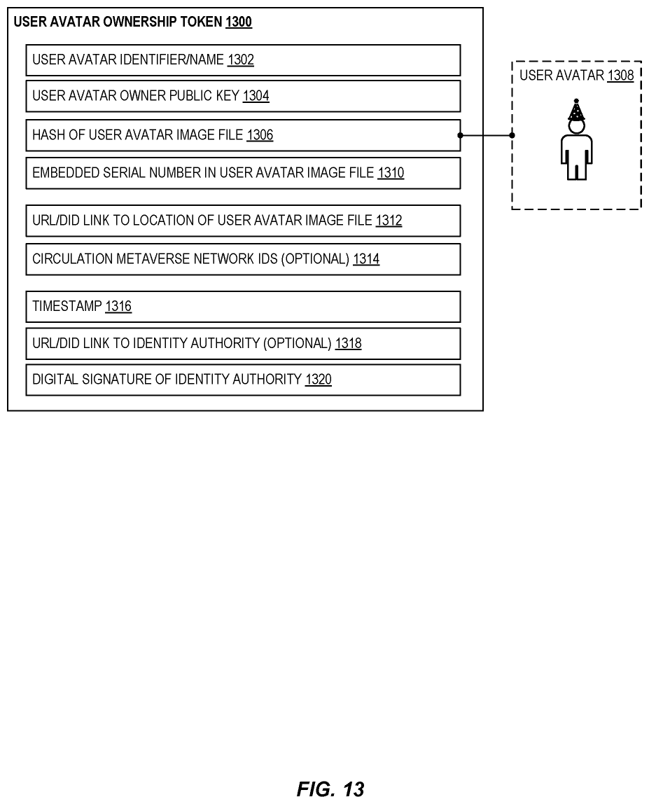

FIG. 13 is a diagram illustrating an overview of a user avatar ownership token data structure on the asset trading ledger 1020 according to some examples. As shown, the user avatar ownership token 1300 can include some or all the following data fields: a user avatar identifier/name 1302, a user avatar owner public key 1304, a hash of the user avatar image file 1306 (or other type of digital data representing a user avatar 1308, which can include an embedded serial number), the embedded serial number in the user avatar image file 1310, a URL/DID link to a location of the user avatar image file 1312, one or more circulation metaverse network identifiers 1314 (optional), a timestamp 1316, a URL/DID link to an identity authority 1318 (optional), and a digital signature of the identity authority 1320. This allows the holder of the private key (i.e., the user), for example, to prove the possession of the private key through a challenge response authentication protocol, as described elsewhere herein.

In some examples, a user avatar ownership token 1300 can be issued/signed by an identity authority, which can in some examples be the entity that operates the asset consistency management system 100. However, the token is flexible in that it permits a user to self-register and assert that they are their own identity authority. When a user uses the asset consistency management system 100 to register the ownership of their user avatar to the asset trading ledger 1020 via the use avatar ownership token data structure, in some examples, the asset consistency management system 100 validates that the claimed user avatar image is sufficiently unique compared to other registered user avatar image files.

### User Avatar State Tokens

In some examples, user avatar state tokens are used to register or “track” users and their avatars within the metaverses in which they are currently present (via their graphical user-avatars). The recording of a user avatar state token onto the metaverse tracking ledger 1000 presumes that the user avatar ownership token has been created (registered) at the asset trading ledger 1020.

In order to ensure that a user who wields (in a metaverse) a branded object avatar (or other type of object avatar) is able to prove their authenticity, in some examples, both user avatars and objects avatars are to be registered within the metaverse tracking ledger 1000. The metaverse tracking ledger 1000 is used, among other purposes, to aid in the authentication of users (user-avatars) and the validation of the authenticity of branded object-avatars. If a user fails to register a user avatar state token (for their user avatar) prior to entering a metaverse using their user avatar, in some examples, the user may not be able to prove ownership of the user avatar when challenged (e.g., by other users who may have similar-looking avatars or who have simply stole/copied the avatar image). The asset consistency management system 100, metaverse, or other system can then take action to prevent the user from using the user avatar in the metaverse or taking any other desirable action.

In some examples, a user avatar state token is used for the following types of presence registration in a metaverse, which operate as pairs (open/close):

Register an entrance into a metaverse: A user avatar state token can be used to indicate a user's entrance into a metaverse identified by the metaverse network identifier. In some examples, there is one entrance state token for a given metaverse.

Register departure from a metaverse: A user avatar state token can also be used to indicate the user's departure from a metaverse identified by the metaverse network identifier. In some examples, this token includes a hash of the previous matching entrance state token (e.g., such that it closes the previous entrance).

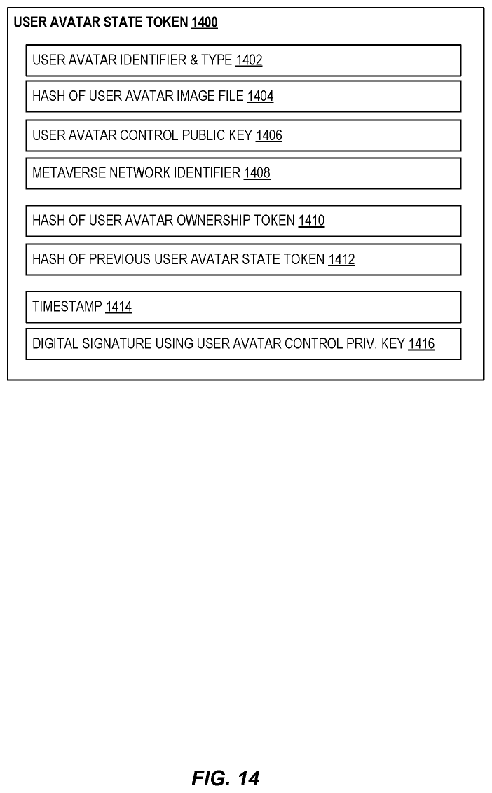

In some examples, the asset consistency management system 100 validates the metaverse tracking ledger 1000 for the entrance and departure pairs of user-avatar state tokens for a given metaverse. FIG. 14 is a diagram illustrating an overview of a user avatar state token data structure on the tracking ledger according to some examples. In some examples, the information contained within a user avatar state token 1400 can include an identifier/name of the user avatar and the type (e.g., “user” type) 1402, a hash of the user avatar image file 1404, a user avatar control public key 1406 (e.g., the control public key associated with the graphical digital representation (i.e., the avatar image) in the given metaverse, where this key pair is unique per metaverse (even for the same user-avatar image file)), metaverse network identifier 1408 (e.g., an identifier of the metaverse where the user has introduced the user avatar), a hash of a corresponding user avatar ownership token 1410 (e.g., the hash of the ownership token previously registered at the asset trading ledger 1020), a hash of previous user avatar state token 1412, (e.g., this value is present when this token expresses a departure from a metaverse and represents a hash of a previous user avatar state token registered when the user first entered the metaverse, a timestamp 1414, and a digital signature using user avatar control private key 1416 (e.g., this signature is performed using the control private key of user avatar which is held by the user).

It is noted that a user avatar control public key is the key utilized by the user within the metaverse. Thus, this public key accompanies the user avatar while it is present or active in a given metaverse. Additionally, a user avatar control public key is unique for each metaverse (independent of the user avatar image). Therefore, if a user employs the same user avatar image for N different metaverses, then there can be a unique control key pair for each of these metaverses (and correspondingly there will be N different user avatar ownership tokens on the asset trading ledger 1020).

### Branded Object Avatar State Tokens

In some examples, an object avatar state token is used to track branded object avatars (and possibly other types of object avatars), and the metaverses in which they are currently present (via their avatars). In some examples, brand owners permit branded object avatars (e.g., genuine Gucci® handbags avatar) to be displayed by (or associated with) a user only if (i) the branded object avatar state tokens have been recorded (or registered) on the asset trading ledger 1020 by the brand owner, (ii) the user/person has registered their user avatar state token on the metaverse tracking ledger 1000, and that (iii) the user is the legal owner of the asset instance corresponding to the branded object avatar.

There are a number of aspects related to branded object-avatars and their ownership. For each branded object avatar within each metaverse, in some examples, there is one unique state token recorded in the metaverse tracking ledger 1000. When an issuer (e.g., brand owner) of a product/asset creates N products (e.g., real-world goods), in some examples, it also uses the asset consistency management system 100 to create (or register) N asset instances for its product on the asset trading ledger 1020. Initially, the issuer is the legal owner of all N asset-instances (e.g., as illustrated by the asset ownership token 1200 in FIG. 12). Over time, when it sells the product to buyers, new asset ownership tokens can be assigned to the buyers.

For each of the N given asset ownership tokens on the asset trading ledger 1020 (for the N asset instances), in some examples, the issuer creates (register) N corresponding metaverse object-avatar state tokens on the metaverse tracking ledger. At the start of the product issuance, the issuer holds the object avatar control key pair for each of the N given object avatar state tokens on the metaverse tracking ledger 1000.

For example, the Gucci® corporation legal brand owner can first use a computing device to register a Gucci® handbag avatar (as an asset) into tracking ledger before any user owning the asset can display that handbag's avatar in a metaverse.

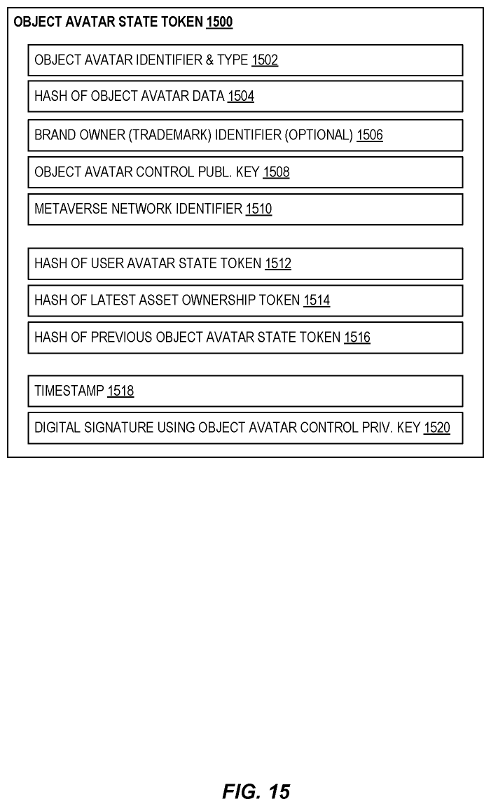

In some examples, information contained within a branded object-avatar state token can include the following. FIG. 15 is a diagram illustrating an overview of an object avatar state token 1500 data structure according to some examples. A token 1500 can include an object avatar identifier and type 1502 (the type can be a “branded object”), a hash of avatar data 1504 (e.g., a cryptographic hash of the branded object avatar image file or other data used to display the object avatar in metaverses, and which is the same as defined in the corresponding asset instance (for the branded object/goods) registered on the asset trading ledger 1020 by the brand owner (as shown in FIG. 8). It is noted that each branded object avatar image file or other data can contain a unique embedded serial number. In some examples, a token 1500 can further include identifier 1506 of the brand owner or trademark owner, the branded object avatar control public key 1508 (e.g., the public key of the key pair under the control of the current owner of the branded asset instance), a metaverse network identifier 1510 (e.g., an identifier of the metaverse where this branded object-avatar is to be used), and a hash of the user avatar state token 1512 to which this branded object avatar is bound. If the asset instance corresponding to this branded object avatar is new (unsold), it is initially bound to the issuer or brand owner of the asset instance.

In some examples, a token 1500 further includes a hash of the asset ownership token 1514 (on the trading ledger) that corresponds to (bound to) this branded object-avatar, a hash of the previous branded object-avatar state token 1516 (if any), a timestamp 1518, and a digital signature using controller private key 1520 of the branded object avatar.

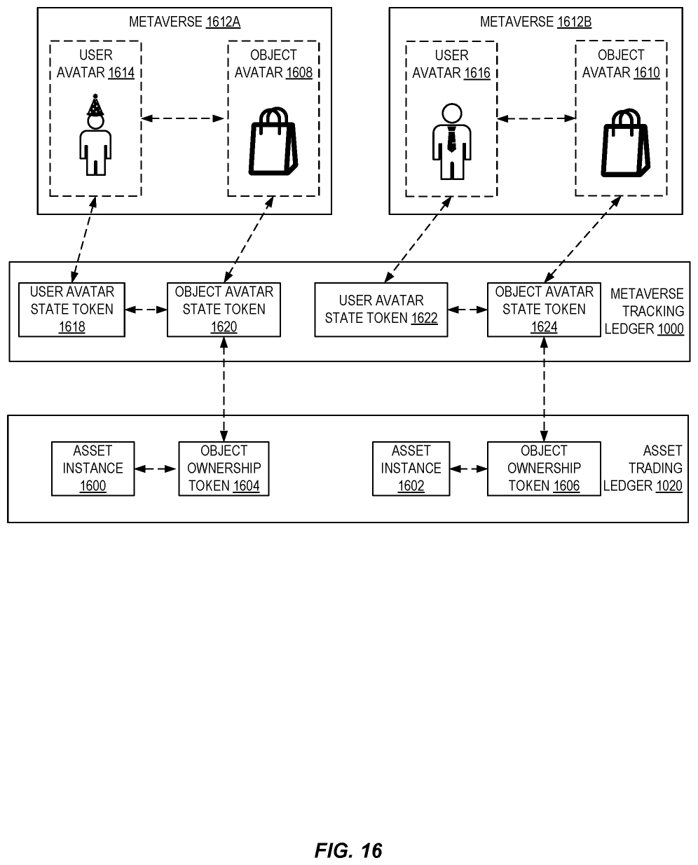

FIG. 16 is a diagram illustrating an example of two object avatar state tokens that have been registered on the tracking ledger and are deployed in different metaverses according to some examples. Here, each of two asset instances (e.g., an asset instance 1600 and an asset instance 1602) is legally owned via two unique asset ownership tokens on the asset trading ledger 1020 (e.g., via an object ownership token 1604 and an object ownership token 1606). The object avatar data (e.g., shown as object avatar 1608 and object avatar 1610) displayed in the metaverses 1612A and metaverse 1612B, in connection with a user avatar 1614 and a user avatar 1616, respectively) correspond to the file as that found in the registered asset instance (as defined by the brand owner). These files each contain a unique embedded serial number (or “ESN”) that is recorded as part of the asset instance registration by the brand owner. Thus, although the object avatar graphical images (e.g., the object avatar 1608 and object avatar 1610) may appear visually identical to the human eye, they have an embedded serial number that acts as a watermark which is invisible to the eye. However, each of these files when hashed (e.g., using a cryptographic one-way hash function) produces a different hash value. As shown, the user avatar 1614 is tracked via a user avatar state token 1618, the object avatar 1608 is tracked via an object avatar state token 1620, the user avatar 1616 is tracked via a user avatar state token 1622, and the object avatar 1610 is tracked via an object avatar state token 1624, each stored on the metaverse tracking ledger 1000.

Although an object avatar graphical image file can be stolen in the metaverse (including a stolen ESN serial number), the control of object avatar in a metaverse is enforced using the control key pair. This key pair is in the hands of the legal owner of the asset instance. An authentication protocol for object avatars is discussed elsewhere herein.

### Physical Object State Tokens & Depository Receipts

In some examples, a physical object state token is utilized on the physical logistics ledger 1032 as the means to maintain a record or log as to the physical location of a given real-world asset corresponding to a branded object asset instance or other object asset instance. The token contains sufficient information regarding the corresponding real-world asset to be able to uniquely identify the object instance from a series of seemly identical products. This is relevant for manufacturers of scarce goods (e.g., luxury products) who wish to know the status of one of its products. When a manufacturer issues a new product item instance, in some examples, it creates a new physical object state token which reports/logs (e.g., using a status code) that the items are in the hands of dealers. This allows the manufacturer and dealer to keep track of the product instance through its life cycle (which may be decades long for certain grades of luxury goods).

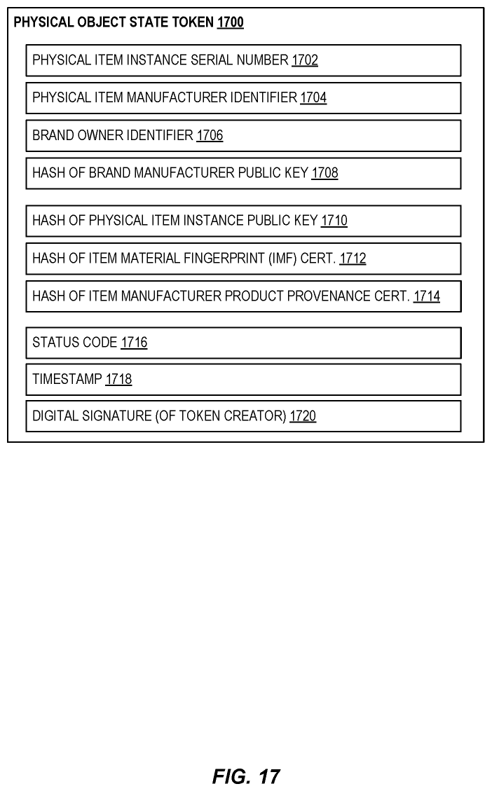

FIG. 17 is a diagram illustrating an overview of a physical object state token data structure according to some examples. As shown, a physical object state token 1700 can include a physical item instance serial number 1702, a physical item manufacturer identifier 1704, a brand owner identifier 1706, a hash of a brand manufacturer public key 1708, a hash of physical item instance public key 1710, a hash of an item material fingerprint (or “IMF”) certificate 1712, a hash an item manufacturer product provenance certificate 1714, a status code 1716, a timestamp 1718, and a digital signature (of the token creator) 1720.

In some examples, for a given real-world asset, a physical object state token can report the asset to be in one of at least four (4) major states (or status codes) (with minor codes to indicate further information):

Customer possession: This indicates that physical object is in the physical care of its legitimate customer.

Dealer possession: This indicates that an authorized dealer (e.g., a shop) belonging to the manufacturer is in possession of the physical object for one reason or another. For example, the object could be a new product instance (unsold), it could be undergoing repairs by the dealer, or the owner has handed over the physical object to the dealer for a reason (e.g., safe keeping during time away, etc.).

Depository possession: This indicates that a legally recognized depository entity is in possession of the physical object. An example of a depository could be bank.

Reported Lost (Unknown): This indicates that the physical object is reported to be lost by the party who last possessed the item. For example, its legal owner could report it as lost, or a dealer that experienced theft could also report it as lost/stolen.

In some examples, a physical object state token can be signed either by the current owner (i.e., a user) who has been registered within the asset consistency management system 100, or by a third party such as an authorized dealer or legal depository. In some examples, the depository receipt is used by (i) an authorized dealer or (b) legally recognized depository to confirm the assertion made by a user within a physical object state token. That is, in the case that the token was created and signed by a user, the depository receipt can be used as a means for a dealer to support (i.e., to second) the claim by the user.

### System Functional Tokens

In some examples, the asset consistency management system 100 also employs system functional tokens that it utilizes to control the operations of the three decentralized ledger subsystems in order to achieve consistency across them. In some examples, a system token can only be issued by the asset consistency management system 100 and it typically points to (includes a hash of) a target token or asset upon which the function applies. For example, a lock token that points to (includes a hash of) a given asset ownership token means that the targeted token (i.e., ownership token) cannot be modified (i.e., a new one created) until such time that the lock is removed (e.g., unlock token).

The following are example types of system tokens:

Lock/unlock tokens: A lock token can be used by the asset consistency management system 100 to denote that the target token or asset is in a locked state and that its state cannot be modified until a matching unlock token is issued. Thus lock/unlock tokens are applied in pairs.

Time lock tokens: In some examples, a time lock token is used by the asset consistency management system 100 to denote that the target token or asset is in a locked state until the expiration of the time specified in the time lock token.

Invalidate token: An invalidate token can used by the asset consistency management system 100 to denote that the target token or asset is no longer valid (i.e., permanently invalid).

An invalidate token can be used, for example, to invalidate a branded object avatar state token (e.g., on the metaverse tracking ledger 1000) when the user who wields that avatar is not (or is no longer) the legitimate owner of the asset represented visually by that object avatar.

The invalidate token can be used on the tracking ledger to signal (to other users and entities in the metaverse) that a user is cheating by showing off a branded object avatar that the user does not own (i.e., a displayed object avatar is a counterfeit). This allows other entities (e.g., venue owners) to “eject” the user from the venue or from the metaverse.

### Metaverse Venues and Events

Within a metaverse, venues and events represent assets that may be scarce and time-bound (i.e., its value has a time limit). A venue in a metaverse is represented by a venue avatar that is owned and controlled by the venue owner. If the metaverse venue is bound to a real-world physical venue, then we refer to it as a duality venue. A metaverse-venue that exists solely in the metaverse is referred to as a singularity venue.

Singularity events and singularity ticket asset instances: In some examples, a singularity event is an event that occurs only in the metaverse (within a specific unique metaverse network identifier). Access to this type of event is subject to a user possessing (e.g., purchasing) an instance of the singularity ticket asset prior to the event date/time.

Duality events and duality ticket asset instances: In some examples, a duality event is an event that occurs simultaneously (at the same date/time) in both in the metaverse and the real-world physical venue. Access to this event is subject to a user possessing (e.g., purchasing) an instance of a duality ticket asset prior to the event date/time. Here, access means that the user can attend the event in the physical venue.

It is noted that a human person (user) may bring their electronic computing devices (e.g., laptops, mobile phones, etc.) to the real-world physical venue and attend the metaverse event simultaneously computing devices. This ability to attend both the physical event and the metaverse event represents an experiential asset that may be valuable to many users.

### Venues, Events and Tickets as an Asset

In some examples, the combination of a metaverse event and a metaverse venue represents a virtual asset that is scarce and timebound because access to it can be limited by certain factors. For example, a brand owner as an organization entity in the metaverse can create a duality event that includes a duality venue simultaneously, namely, in the metaverse and in the real-world. Both may occur at a given moment in time and for a duration of time, after which the duality-event ceases to exist. Although both the metaverse venue and the physical venue may continue to exist, the event itself has passed in time.

For example, a luxury goods manufacturer (e.g., a brand owner) may create a duality event called “Spring Fashion Launch” that occurs in the metaverse and in the physical world simultaneously during the first week of May. Here, the brand owner may not only display certain new metaverse duality assets (e.g., new handbags), but also sell these duality assets during the event. Thus, when a user purchases a new duality asset within (during) a duality event, the user legally owns the asset in the metaverse (represented by the object avatar) and the physical object in the real world). Thus, access to this event is a scarce event that may be desirable to many users. The brand owner may even restrict the sale of the asset to occur only during the metaverse event.

For the users (i.e., potential buyers) of the duality assets during the event, the users can immediately display the brand object-avatar in the metaverses that the user participates in. This capability provides an attractive business model for the brand owners, collectors, and users generally.

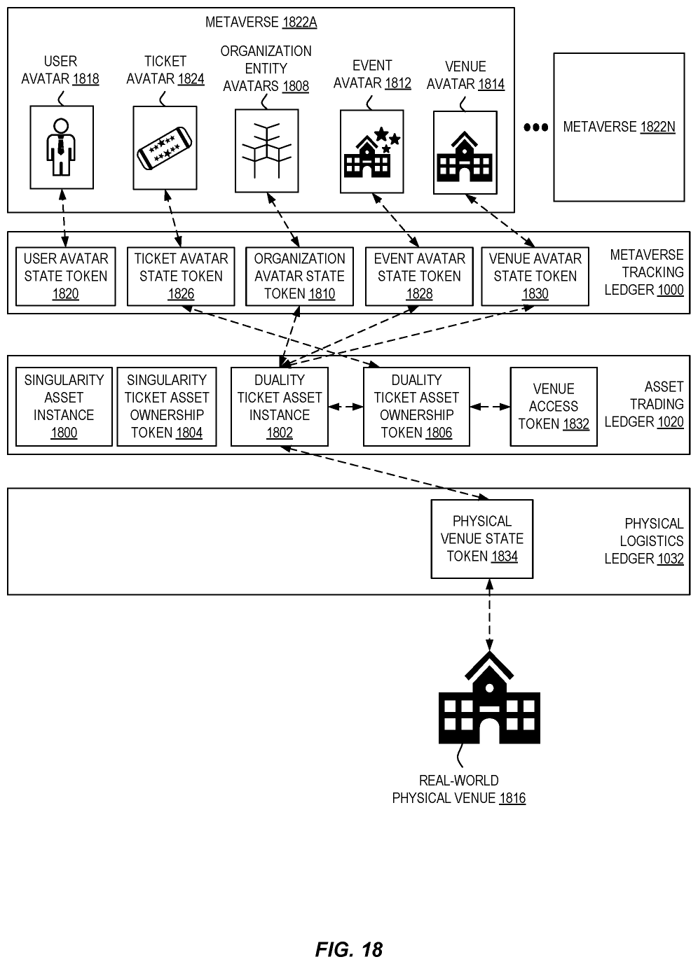

In some examples, access to a metaverse event and a metaverse venue is conditioned on possession of a ticket asset instance on the asset trading ledger 1020. A given ticket asset instance can be of at least two types, namely be a singularity ticket asset instance or a duality ticket asset instance. FIG. 18 is a diagram illustrating an overview of a metaverse duality event and a duality ticket asset instance according to some examples. In FIG. 18, an overview is provided of a metaverse duality event, consisting of the following example parties, assets, and tokens.

Ticket asset instance (singularity or duality): A ticket asset instance (e.g., a singularity asset instance 1800 or a duality ticket asset instance 1802) represents the valuable asset that can be sold or traded on the asset trading ledger 1020 of the asset consistency management system 100. A brand owner as the event organizer can issue N number of the ticket asset instances on the asset trading ledger 1020 and make them available for sale at some point in time (e.g., close to the event date). A set of ticket asset instances can be defined to be non-re-assignable (or non-resalable), which indicates that the ticket asset instance cannot be resold once the brand owner assigns its ownership to a user or entity via a ticket asset ownership token (e.g., a singularity ticket asset ownership token 1804 or a duality ticket asset ownership token 1806).

In some examples, a ticket asset instance includes relevant pointers to the organization (i.e., brand owner) who is organizing the event (represented by organization entity avatars 1808, linked to a duality ticket asset instance 1802 via an organization avatar state token 1810 in the example of FIG. 18), the event name and avatar (e.g., represented by an event avatar 1812), and the venue (e.g., represented by a venue avatar 1814), which is a duality of metaverse network identifier and the real-work physical location (e.g., a real-world physical venue 1816). As shown, these venues can be attended by a user using a user avatar 1818 associated with a corresponding user avatar state token 1820 in a metaverse (e.g., a metaverse 1822A, . . . , 1822N). As shown, metaverses can further include ticket avatars 1824 associated with corresponding ticket avatar state tokens 1826, and the event avatars 1812 can be associated with an event avatar state token 1828, and a venue avatar 1814 can be associated with a venue avatar state token 1830. As shown, a duality ticket asset ownership token 1806 can be associated with a venue access token 1832, and a real-world physical venue 1816 can be associated with a physical venue state token 1834 on the physical logistics ledger 1032.

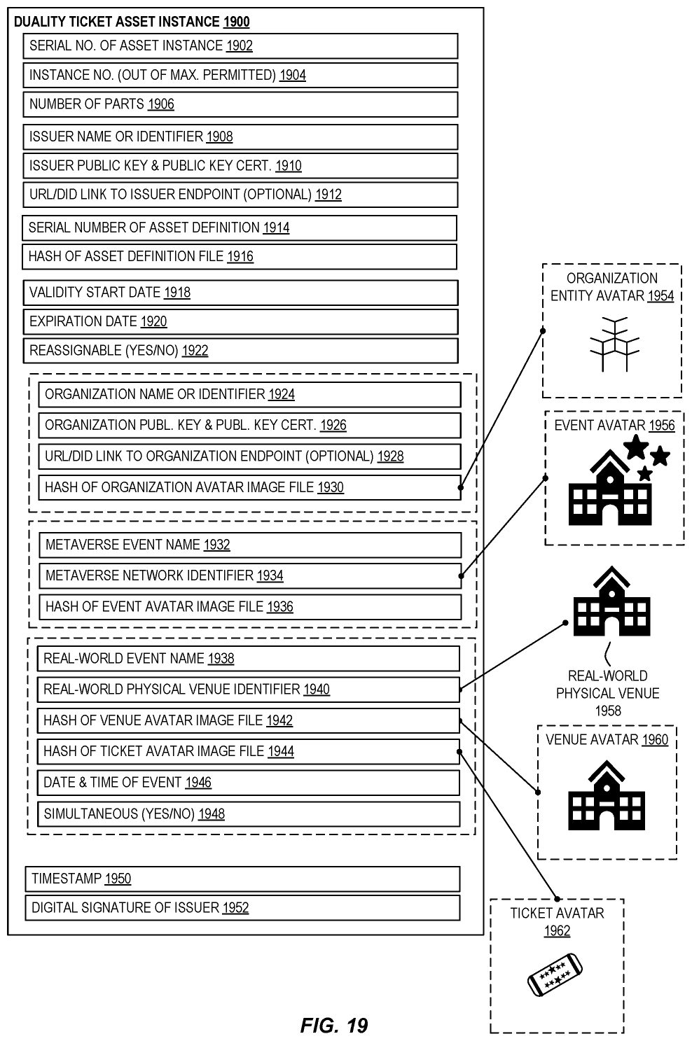

In some examples, the signature on all the N ticket asset instances is to be prior to (earlier than) the event start date/time, which is recorded as the validity start date in FIG. 19. In other words, the N ticket-asset instances are to be already registered in the asset trading ledger prior to the date of the event.

Ticket asset instance ownership token: The ownership token for ticket asset instances (singularity or duality) is largely similar as other types of assets (e.g., as illustrated in FIG. 12).

After the brand owner as the event organizer uses the asset consistency management system 100 to register the N ticket asset instances on the asset trading ledger 1020, in some examples, the brand owner as the asset issuer may then issue N instance ownership tokens on the trading ledger, where all the N ownership tokens are assigned to the brand owner (assign to self). Once the ticket sale or ticket assignment (gift) period opens, the brand owner can then begin selling the instance ownership tokens to users and entities on the trading ledger.

Venue access token: In the case of a duality ticket asset instance, in some examples, the instance ownership token is tied to a matching venue access token (e.g., venue access token 1832) on the asset trading ledger 1020. Thus, when the brand owner registers the N ticket asset instances on the asset trading ledger 1020, in some examples, it also registers N venue access tokens on the asset trading ledger 1020. A venue access token 1832 has the same lifetime as the ticket asset instance and is used primarily as mechanism to enter the real-world physical venue.

A given venue access token can be loaned to another user (bearing a different user avatar) in the case where the owner of the ticket asset instance is unable to physically attend the real-world physical venue. This is convenient for cases where the owner (e.g., user U1) attends the metaverse event, but another user (e.g., U2) attends the real-world physical venue.

When a brand owner initially sells (assigns) a ticket asset instance to a user/entity on the asset trading ledger 1020, in some examples, the brand owner also assigns the matching venue access token on the trading ledger to that same user/entity. The venue access token is utilized by its holder later during attendance in-person at the real-world physical venue. Prior to entering the physical venue, in some examples, the holder of the venue access token proves to the venue owner that it knows the ownership private key of the duality asset ownership token. User authentication and object avatar authentication is discussed elsewhere herein.

### Ticket Asset Instances

As mentioned above, a duality event represents an interesting combination of an event that is occurring simultaneously in a metaverse and within a real-world physical location. For many user communities (e.g., fashion aficionados), access to such an event is valuable and the duality event is only accessible to a user if the user possesses a duality ticket asset instance.

FIG. 19 is a diagram illustrating an overview of a duality ticket asset instance on the asset trading ledger according to some examples. As shown, a duality ticket asset instance 1900 can include a serial number of the asset instance 1902, an instance number 1904 (out of a maximum permitted number of instances), a number of parts 1906, an issuer name or identifier 1908, an issuer public key and public key certificate 1910, a URL/DID link to an issuer endpoint 1912 (optional), serial number of the asset definition 1914, a hash of the asset definition file 1916, a validity start date 1918, an expiration date 1920, whether the instance is re-assignable 1922, an organization name or identifier 1924, an organization public key & public key certificate 1926, a URL/Did link to an organization endpoint 1928 (optional), a hash of an organization avatar image file 1930, a metaverse event name 1932, a metaverse network identifier 1934, a hash of an event avatar image file 1936, a real-world event name 1938, a real-world physical venue identifier 1940, a hash of the venue avatar image file 1942, a hash of the ticket avatar image file 1944, a date and time of the event 1946, an indication of whether the duality events are simultaneous 1948, a timestamp 1950, and a digital signature of the issuer 1952. As shown, various parts of the instance 1900 identify an organization entity avatar 1954, an event avatar 1956, a real-world physical venue 1958, a venue avatar 1960, and a ticket avatar 1962.

Unlike duality object assets, a ticket asset is only valid for a specified period time, namely, the time of the event. This is represented, e.g., by the validity start date 1918 and expiration date 1920 in the example instance 1900. The ticket-asset instance also includes fields pertaining to the organization who is the event-organization (e.g., brand owner) (e.g., fields 1924-1930). It includes fields pertaining to the specific metaverse event (e.g., “Spring Runway”) (e.g., fields 1932-1936), the real-world physical location identifier (e.g., GPS location or coordinates) for the event (e.g., fields 1940), and the venue avatar for the metaverse venue where the event will be held (e.g., field 1942). Also included in the ticket avatar which contains an embedded serial number (similar to brand object avatars).

For a manufacturer or a brand owner of scarce goods (e.g., luxury products), a duality event provides an opportunity to sell new branded duality assets during the event. Brand owners may restrict purchase of new branded duality assets to be only available during the duration of the duality event (e.g., defined by the ticket asset instance, for example, based on the validity start date and expiration date of the ticket instance). For example, a brand owner (e.g., Gucci® Inc.) may make available a new physical product (e.g., “Spring 2022 handbag”) with a limited quantity of 25 units during its spring event (e.g., “Spring Runway 2022”). In this example, the brand owner as the asset issuer will issue/record 25 duality-asset instances on the asset trading ledger, where the ownership of the 25 instances initially (prior to the event date) belongs to the brand owner. Thus, there will also be 25 asset ownership tokens that correspond to the 25 duality-asset instances, where each token is assigned to the public key of the brand owner. Users can purchase one or more of the duality asset instances under additional conditions, described elsewhere herein.

### Constraints on Buyers of Branded Duality Assets During a Metaverse Duality Event

Since a metaverse duality event (occurring simultaneously in a metaverse and in the real-world physical venue) may be an opportunity to launch new metaverse duality assets, in some examples, the brand owner may take several precautions to prevent unauthorized purchases and other related undesirable behavior by users.

The following conditions, in some examples, can be maintained before a user (wielding a user avatar) can enter the designated metaverse and enter designated real-world physical venue:

The user is a registered ticket holder: One example condition is that the user is the current owner of a duality ticket asset instance (as recorded in the matching duality ticket asset ownership token). For example, the user can prove it is the current owner by demonstrating that it holds the private key matching the public key stated in the ownership token.

User avatar authentication: Another example condition is the user performing user avatar authentication to the venue avatar (i.e., owner of venue). For example, the user wielding a user avatar can perform the metaverse authentication protocol for user avatars. Here, the venue avatar controller acts as the querier, while the user acts as the responder.

Ticket avatar authentication: Another example condition is that the user brings along the user's assigned ticket avatar (who hash of the image file in contained in the duality ticket asset instance). Similar to an object avatar, the ticket avatar is considered an object and thus the user executes the object avatar authentication protocol. The venue avatar controller acts as the querier, while the user acts as the responder.

Brand object avatar authentication: Another example condition is the user performing object avatar authentication for every brand object avatar (e.g., bag avatar, accessories avatars) that the user brings into the event in the metaverse venue. The venue avatar controller acts as the querier, while the user acts as the responder. A goal here is to prevent the user attending the event bringing (displaying) counterfeit brand object-avatars (i.e., fake goods).

### Metaverse Authentication Protocol (MAuth)

There are numerous use case scenarios in the metaverse that may involve the authentication of entities (e.g., users, brand owners, venue owners, etc.), objects (e.g., brand avatar objects), and venues. In some examples, each of the “querier” and “responder” can represent computing devices, e.g., used by users to access an asset consistency management system 100, metaverses, and other networked computing services via one or more computing networks (e.g., including the public internet).

When a user bearing a user avatar (e.g., UAV1) is present in a given metaverse, other users or entities in the same metaverse can challenge (e.g., using an associated computing device) the user to prove the authenticity and ownership of the user avatar (e.g., using a computing device). If the user avatar additionally bears an object avatar (e.g., a branded object avatar), the user may be challenged to prove that the object avatar is genuine (e.g., not counterfeit).

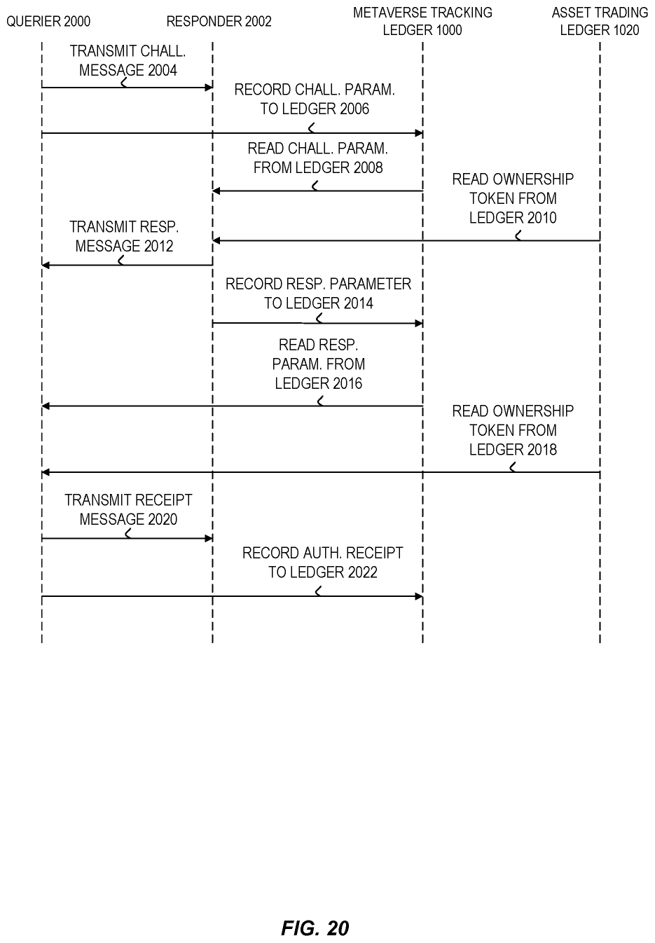

FIG. 20 is a diagram illustrating an overview of a metaverse authentication protocol (or “MAuth” protocol) message flows according to some examples. In the example of FIG. 20, the example flow refers to a user challenging another user as the querier (e.g., querier 2000, the party asking the query), while the other user as the responder (e.g., the responder 2002). As shown, the protocol involves use of at least the metaverse tracking ledger 1000 and the asset trading ledger 1020 of the asset consistency management system 100.

In FIG. 20, the querier 2000 uses a computing device to transmit 2004 a challenge message to the responder 2002 (e.g., to a computing device associated with the responder via a computer network). In some examples, the message contains cryptographic parameters meaningful to the responder 2002. Additionally, the querier 2000 uses a computing device to record 2006 a challenge parameter (from the challenge message) onto the metaverse tracking ledger 1000 to prove that the querier has access to the tracking ledger and thus a legitimate entity within the asset consistency management system 100.

After deciphering the challenge message received from the querier 2000, the responder 2002 reads 2008 the challenge parameter that was recorded on the metaverse tracking ledger 1000. This action provides assurance to the responder 2002 that the original challenge message came from a legitimate querier 2000 who is known (registered) in the metaverse tracking ledger 1000. Optionally, to prove that the querier 2000 owns the user avatar in the metaverse, the responder 2002 may search 2010 through confirmed transaction blocks on the asset trading ledger 1020 to look for the user avatar ownership token that contains the same identifier and hash image as that of the querier's user avatar.

In some examples, the following are the actions performed by the responder 2002. The responder 2002 then answers the challenge message by transmitting 2012 a response message directly to the querier 2000. The responder 2002 also records 2014 a challenge parameter of the response message onto the metaverse tracking ledger 1000 to prove that the responder 2002 has access to the metaverse tracking ledger 1000 and thus a legitimate entity within the asset consistency management system 100.

In some examples, after deciphering the response message received from the responder 2002, the querier 2000 reads 2016 the challenge parameter that was recorded on the metaverse tracking ledger 1000. The querier 2000 can optionally search 2018 through the confirmed transaction blocks on the asset trading ledger 1020 to look for the user avatar ownership token that contains the same identifier and hash image as that of the responder's user avatar.

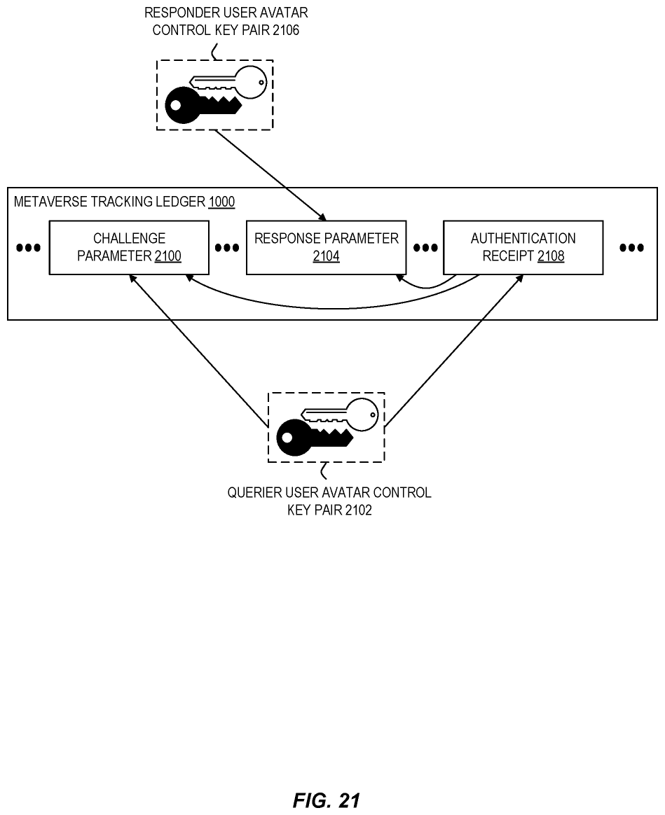

In some examples, the querier 2000 as the side who initiated the authentication event provides a receipt message to the responder 2002 and also record an authentication receipt data structure the tracking ledger. FIG. 21 is a diagram illustrating an overview of the authentication receipt data structure that contains links to the challenge parameter and response parameter data structures on the tracking ledger according to some examples. As shown, a challenge parameter 2100 is signed by a querier using a querier user avatar control key pair 2102, a response parameter 2104 is signed by a responder using a responder user avatar control key pair 2106, and the authentication receipt 2108 is signed by the querier using the querier user avatar control key pair 2102 and relates back to the response parameter 2104 and the challenge parameter 2100.

In some examples, the querier 2000 can transmit 2020 receipt message to the responder 2002 communicating the fact that the authentication event was successful. The message includes a copy of the challenge parameter that it has sent in the challenge message.

In some examples, the querier 2000 records 2022 the authentication receipt onto the metaverse tracking ledger 1000. This signifies to other entities on that ledger that at that given moment in time the authentication event had occurred successfully. The authentication receipt data structure contains a link to the previous challenge parameter and response parameter on the metaverse tracking ledger 1000 for this this receipt pertains (e.g., as described above in relation to FIG. 21). In the next subsections, additional aspects of the above MAuth protocol are described when implemented for user avatar authentication and for brand object avatar authentication. Each of these two cases utilize different message payloads, and these will be described herein.

### User Avatar Authentication

In some examples, a metaverse authentication protocol for user avatars (or “MAuth-User”) permits users, who can be associated with (that is, claim to own) a given user avatar in a metaverse, to prove, using a computing device, that: (a) the user is the controller of the user avatar, and (b) the user is the registered owner of the user avatar. Similar to above, in some examples, each of the “querier” and “responder” can represent computing devices, e.g., used by users to access an asset consistency management system 100, metaverses, and other networked computing services via a computing network.

An entity in a metaverse (e.g., other users, organizations, etc.) may, using a computing device, act as a querier that challenges the user, who takes on the role of the responder to prove aspects of the user-avatar. Following from the MAuth authentication protocol (e.g., as described in connection with FIG. 20), the user avatar authentication protocol based on MAuth is summarized as follows. In the following description, the querier 2000 is the user with avatar “UAV7,” while the responder is the user with avatar “UAV1”:

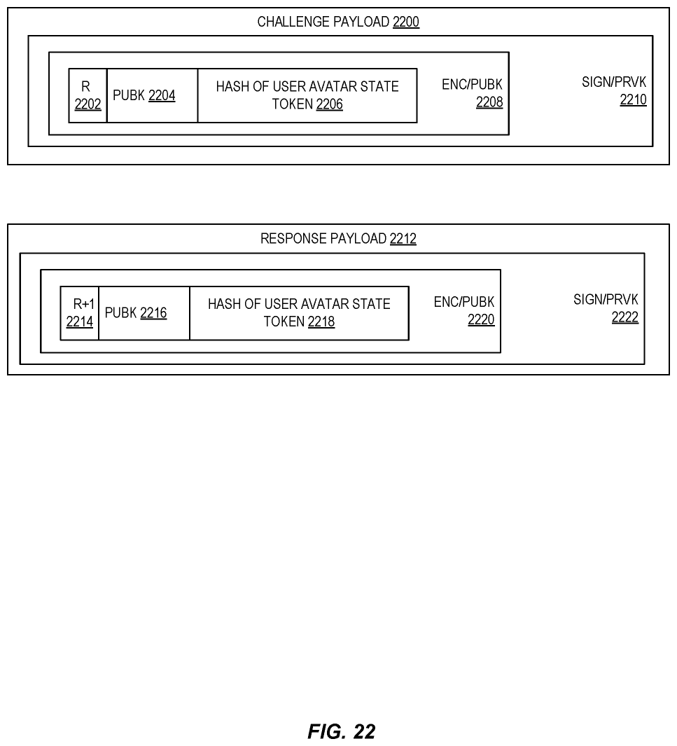

The querier 2000 transmits 2004 the challenge message to the responder 2002, with the message carrying the payload (e.g., a challenge payload 2200 in FIG. 22). In some examples, the challenge payload 2200 consists of the following parts: a random number R 2202 that is generated by the querier 2000, a copy of the user avatar control public key 2204 belonging to the querier (e.g., associated with user avatar “UAV7”), and a cryptographic hash 2206 of the user avatar state token for user associated with avatar “UAV7” on the metaverse tracking ledger 1000. This proves that the avatar “UAV7” has been registered on the metaverse tracking ledger 1000 and that therefore its user avatar ownership token is present on the asset trading ledger 1020. In some examples, a concatenations of the random number 2202, the public key 2204, and the cryptographic hash 2206 are encrypted by the querier using the responder's (e.g., user associated with the avatar “UAV7”) user avatar control public key 2208 (and similarly for public key 2220 in the response payload 2212), which is present (readable) in the metaverse, bound to the user's user avatar image. In some examples, the signed concatenation is then digitally signed by the querier using its own user avatar control private key 2210 (and similarly by the private key 2222 for the response payload 2212).

In some examples, referring again to FIG. 20, the querier 2000 then transmits the challenge payload to the responder in the metaverse.

As mentioned in connection with the MAuth protocol, the querier 2000 also records 2006 a challenge parameter to the metaverse tracking ledger 1000. In some examples, the challenge parameter consists of the cryptographic hash of the random number R shown, e.g., random number 2202 of the challenge payload 2200 illustrated in FIG. 22. This hash-of-R on the metaverse tracking ledger 1000 is signed by the querier 2000 using its user avatar control keypair.

In some examples, the responder 2002 receives 2008 the challenge payload and verifies the signature of the querier 2000 using the querier' s user avatar control public key, which is present (readable) in the metaverse. The responder then decrypts the payload using its user avatar control private key, yielding the described data items from the challenge payload 2200.

Using the value of R (which it obtained from the decrypted part of the challenge payload 2200), the responder 2002 computes a hash of R and uses the result to search for a match for hash-of-R through confirmed blocks of the metaverse tracking ledger 1000. The goal here is to find a match for the challenge parameter (hash-of-R) that was deposited above by the querier 2000. If it does not find a match, the responder 2002 ignores the remainder of the protocol and stops (i.e., the querier 2000 is either dishonest, erroneous, or an attacker).

If the responder 2002 finds 2016 a match with the challenge parameter on the asset trading ledger, then it obtains assurance of the public key of the querier 2000 on the metaverse tracking ledger 1000. That is, it can learn that the key used to sign the challenge payload (the sign/private key 2210 in FIG. 22) is indeed the same key whose public half is carried in the payload (as public key 2204 in FIG. 22), and that its holder is a legitimate and registered entity in the metaverse tracking ledger 1000.

Using the hash 2206 of the user avatar state token (e.g., for the user avatar “UAV7”), the responder 2002 searches through the confirmed blocks of the metaverse tracking ledger 1000 to search for a matching user avatar state token. In some examples, this is performed by the responder 2002 reading each token record on the metaverse tracking ledger 1000 (in a confirmed block of the ledger), computing a hash of the record, and then comparing the result with the hash 2206 of the user avatar state token in FIG. 22. A successful match indicates that the user avatar (e.g., avatar “UAV7”) has been registered in the metaverse tracking ledger 1000.

In some examples, the responder 2002 prepares a response payload and delivers it to the querier 2000. It composes the response payload 2212 as shown in FIG. 22. In some examples, the response payload 2212 consists of the following parts: a number R+1 that is an increment of the value R received previously in the challenge payload 2200 (e.g., R+1 2214); a copy of the user avatar control public key belonging to the querier (e.g., associated with avatar “UAV1”) (namely, public key 2216 in FIG. 22); a cryptographic hash of the user avatar state token for user U1 (with avatar “UAV1”) on the metaverse tracking ledger 1000 (e.g., hash of user avatar state token 2218 in FIG. 22). This proves, for example, that the avatar “UAV1” has been registered on the metaverse tracking ledger 1000 and that therefore its user avatar ownership token is present on the asset trading ledger 1020.

The concatenations of the items in the response payload 2212 described above in FIG. 22 are encrypted by the responder using the querier's (e.g., associated with avatar “UAV7”) user avatar control public key which is present (readable) in the metaverse, bound to the user's user avatar image. Note that it is the same key that was delivered by the querier in the challenge payload as described elsewhere herein. The signed concatenation is then digitally signed by the responder using its own user avatar control private key (e.g., shown by sign/private key 2222 in FIG. 22)

Returning to FIG. 20, the responder 2002 then transmits 2012 the response payload to the querier 2000 in the metaverse.

Responder also deposits 2014 a response parameter to the metaverse tracking ledger 1000. This consists of the cryptographic hash of the random number R+1. This response parameter (hash-of-R+1) on the metaverse tracking ledger 1000 is signed by the responder 2002 using its user avatar control key pair.

Upon receiving the response payload from the responder 2002, in some examples, the querier 2000 (e.g., associated with avatar “UAV7”) performs a number of validations of the payload contents. First, in some examples, it validates the signature on the payload (as source-authentic from user UAV1) and then decrypt the payload using its own user avatar control private key. It then verifies that the value R+1 is an increment of the value R which the querier 2000 sent in the challenge payload as described herein. The querier 2000 then searches 2016 through the metaverse tracking ledger 1000 for the response parameter (hash-of-R+1) that was deposited by the responder 2002 as described herein. It then uses the hash of the user avatar state token 2218 (e.g., for avatar “UAV1”) to search through the confirmed blocks of the metaverse tracking ledger 1000 to find a matching user avatar state token (e.g., for avatar “UAV1”). In some examples, this is performed by the querier 2000 reading each token record on the metaverse tracking ledger 1000, computing a hash of the record, and then comparing the result with the hash of the user avatar state token 2218 as shown in FIG. 22. A successful match indicates that the user avatar “UAV1” has been registered in the metaverse tracking ledger 1000.

To complete the MAuth protocol, in some examples, the querier 2000 (e.g., associated with avatar “UAV7”) then sends 2020 a receipt message to the responder 2002 (e.g., associated with avatar “UAV1”) to acknowledge a successful authentication.

In some examples, the querier 2000 also records 2022 an authentication receipt data structure to the metaverse tracking ledger 1000 as a means to assert that it has successfully validated responder 2002 (e.g., associated with avatar “UAV1”). The authentication receipt contains a link to the challenge parameter and the response parameter described above.

### Brand Object Avatar Authentication

In some examples, a given branded object avatar can appear visually in a metaverse together with a user avatar that “wields” (carries or bears) it in order to signify ownership of the asset instance being represented by that object avatar. This is of particular interest to brand owners (e.g., luxury goods manufacturers) because there is the possibility that counterfeit branded object-avatars being wielded by a user-avatar (thereby harming the economic value of the brand). Similar to above, in some examples, each of the “querier” and “responder” can represent computing devices, e.g., used by users to access an asset consistency management system 100, metaverses, and other networked computing services via a computing network.

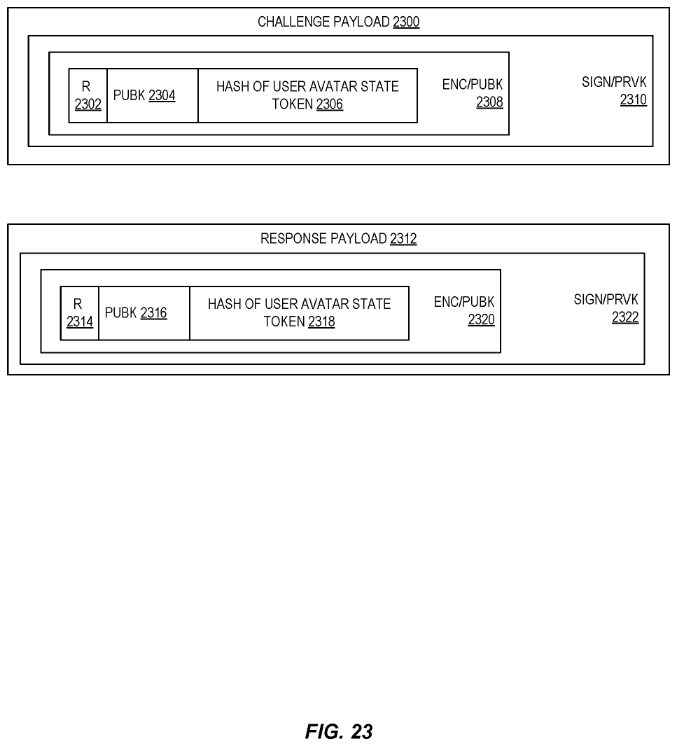

In some examples, a branded object avatar authentication protocol permits an authenticated user, who can wield an object avatar in a metaverse, to prove that (a) the user is the controller of the object avatar, (b) the user is the registered owner of the object avatar, and (c) that the object avatar is genuine and bound to an asset instance legally owned by the user. The challenge/response flow for authenticating a branded object avatar is largely similar to that used for authenticating a user avatar (as illustrated elsewhere herein and in FIG. 22 for the payloads). There are some differences in the case of authenticating a branded object avatar, as shown in the payloads (e.g., the challenge payload 2300 and the response payload 2312) of in FIG. 23 (where a user “UAV9” is challenging the holder object avatar “OAV2”, namely, user “U1”). The challenge payload 2300 similarly includes a random number R 2302, a copy of the object avatar control public key 2304 (e.g., for object avatar “OAV2”), and a hash of the user avatar state token 2306 (e.g., for user “UAV9), while the response payload 2312 includes a random number R+1 2314, a copy of the object avatar control public key 2316 (e.g., for object avatar “OAV2”), and a hash of the object avatar state token 2318 (e.g., for object avatar “OAV2”).

In this example, the responder is the holder of the control key pair for the branded object avatar. Thus, in the challenge message, the querier (e.g., user “UAV9”) encrypts the payload using the object avatar “OAV2” control public key (e.g., the enc/public key 2308 in FIG. 23) without necessarily knowing which user actually own the asset instance. As shown, the challenge payload is further signed with a private key 2310 (e.g., the private key associated with the user “UAV9”) and the response payload 2312 is signed with a private key 2322 (e.g., the private key associated with user avatar “UAV1”).

The response message payload is signed by using a user asset trading key pair. In order to show a cryptographic binding of the object avatar to the user avatar (who owns the asset instance on the asset trading ledger 1020), the user “U1” signs the response payload using the user asset trading private key (e.g., the sign/private key 2322 in FIG. 23). It is noted that this is different from the example shown in FIG. 22.

By performing the signature on the response payload using the user asset trading private key, the user “U1” shows that: (a) the user “U1” is the holder of the branded object avatar control keypair (for “OAV2”) because it can decrypt the payload in the challenge message; (b) the user “U1” is the holder of the asset trading key pair which currently owns the asset instance (on the asset trading ledger 1020) corresponding to branded object avatar (on the metaverse tracking ledger 1000).

### Metaverse Asset Trading Protocol

In some examples, there are several aspects related to the exchange (i.e., sale or trade) of metaverse assets (both singularity assets and duality assets).

Object-avatar state follows asset ownership state: In some examples, the state of a branded object avatar is dependent on the legal ownership status of the digital asset that is visually represented by the avatar in the metaverse. More specifically, when a user sells/trades away the ownership to an asset-instance (either singularity or duality assets), the user is to be prevented from further displaying the object avatar corresponding to that asset instance in any metaverse. That is, the user is to be prevented from pretending to still own the asset-instance by displaying the object-avatar. This is notably relevant, for example, because a user who has ownership of one branded asset-instance may be displaying the branded object-avatar within N different metaverses simultaneously.

Consistency across decentralized ledgers: When an asset instance changes ownership state, then consistency is to be maintained with regards to the object avatar representing it and with regards to the real-world physical asset in the case of duality assets.

Proactive counterfeit-detection and double-spending prevention: In some examples, at all times, the system enforces counterfeit detection and double-spending detection of branded metaverse assets (branded singularity and duality assets). This enforcement may include the system proactively challenging users who wield/display object avatars to prove the authenticity of the object.

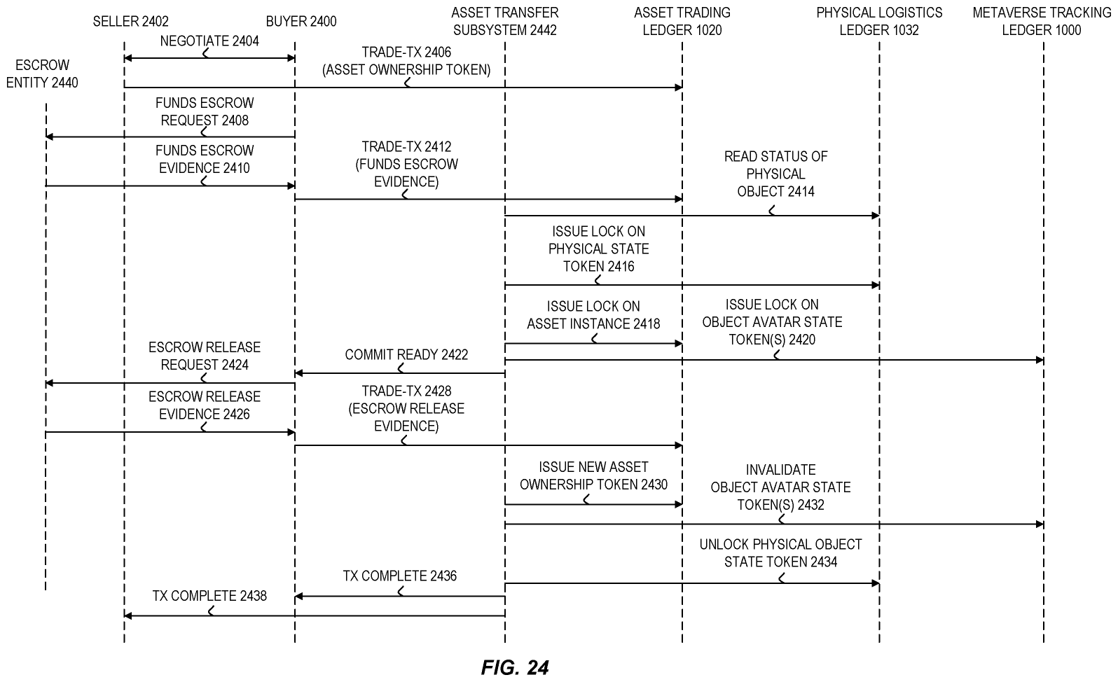

An overview of the asset consistency management system 100 asset trading protocol is shown in FIG. 24 and its phases will be discussed below. The protocol is shown for the trade of a metaverse duality asset involving a real-world object asset. In some examples, the asset consistency management system 100 implements the protocol within its asset transfer subsystem 2442. For a given asset transfer, such as a purchase of a duality asset instance from a seller to a buyer, the price determination is agreed upon by the two sides prior to invoking the asset transfer subsystem of the asset consistency management system 100.

### Lock and Unlock Tokens for Temporary Inaccessibility of Assets

In some examples, the asset consistency management system 100 employs the notion of layers of locks on assets on the ledgers corresponding to the three decentralized ledgers employed by the asset consistency management system 100. The construct of a “lock” is implemented using a special kind of token called a lock token. Similar to above, in some examples, each of the “seller” and “buyer” can represent computing devices, e.g., used by users to access an asset consistency management system 100, metaverses, and other networked computing services via a computing network.

In some examples, a lock token is a signed data structure stored on a decentralized ledger that has a pointer (or hash of) an existing record on the ledger. The semantic meaning is that the record (being pointed to) on the ledger is temporarily inaccessible and that no new records can be created that points to (i.e., contains a hash of) that locked record.

In some examples, only the asset consistency management system 100 can issue a lock token, which can be one of at least two types: (a) a time-based lock token, which specifies a time duration of the lock, and (b) paired lock tokens which can only be undone using a matching unlock token. The utilization of time-based lock tokens and lock/unlock token pairs is dependent on circumstance. FIG. 24 is a diagram illustrating an overview of an asset trading protocol for a duality asset instance according to some examples.

### Phase 1: Verification of Asset State

The goal of Phase-1 of the trading protocol is to ensure that all relevant parts of a metaverse asset are available and ready for the trade between a buyer 2400 and the a seller 2402. This phase assumes that the buyer 2400 and seller 2402 have authenticated each other using the MAuth protocol described elsewhere herein, and that the buyer 2400 has validated the authenticity of the branded object avatar and the asset instance belonging to the seller 2402.

In Phase-1 of the asset trading protocol, several actions occur between the buyer 2400 and the seller 2402 (e.g., including negotiating 2404 a price for the asset).

Identification of asset instance being traded: In some examples, the seller 2402 inputs 2406 the record identification (e.g., hash of record) for its asset ownership token on the asset trading ledger 1020. Note that an entity may own several instances of an asset, and thus the seller 2402 is to be precise and explicit as to which instance is being sold/traded.

Escrow of funds: In some examples, the buyer 2400 sets aside the funds at an escrow entity 2440 (e.g., represented by funds escrow request 2408) and obtains 2410 evidence of the asset escrow from the escrow entity 2440. For example, the evidence can include a digitally signed certificate of escrow, or an escrow token on the asset trading ledger 1020 that has been recorded by the escrow entity using a computing device.

Providing evidence of escrow: In some examples, the buyer 2400 then uses the asset consistency management system 100 to input or otherwise provide this escrow evidence into the asset trading ledger 1020 (e.g., represented by Trade-TX 2412 (funds escrow evidence in FIG. 24) as a means to indicate its desire to proceed with the trade. In some examples, the asset transfer subsystem of the asset consistency management system 100 verifies the escrow evidence.

### Phase 2: Temporary Locking of Assets

In Phase-2 of the asset trading protocol illustrated in FIG. 24, the goal of the asset transfer subsystem 2442 (or “ATS”) of the asset consistency management system 100 is to ensure consistency across the three decentralized ledgers employed in the asset consistency management system 100. The asset transfer subsystem employs lock tokens to temporarily disable assets from being accessed/changed while the trade transaction is occurring. Similar to above, in some examples, each of the seller 2402 and buyer 2400 can represent computing devices, e.g., used by users to access an asset consistency management system 100, metaverses, and other networked computing services via a computing network.

Note that in the example in FIG. 24, the asset being traded is a metaverse duality asset which consists of a metaverse asset part coupled with a real-world asset part. The owner of the metaverse asset is to ensure that the real-world asset (i.e., physical object, such a luxury product or artwork) has been delivered to a depository, and that the depository has issued a depository receipt on the physical logistics ledger.

It is noted that the seller 2402 remains the legal owner of the duality asset even when its real-world asset (physical object) is in the hand of the trusted depository. Legal ownership is determined authoritatively through the asset ownership token (for the asset instance) on the asset trading ledger 1020. A summary of example actions of the protocol is as follows (see FIG. 24).

Verification of status of the real-world asset: In some examples, the asset transfer subsystem 2442 first ensures that the real-world asset (physical object) has been placed in the physical care of the trusted depository. Here, the asset transfer subsystem reads 2414 the most recent depository receipt (for that asset) from the physical logistics ledger 1032. This receipt shows that the owner of the asset has physically delivered the real-world object to the depository and that it is now in the care of the depository. If a receipt cannot be found, the asset transfer subsystem terminates the trade and notifies both buyer 2400 and seller 2402.

Issuance of lock on Physical Object State Token: If a depository receipt (for that asset) on the physical logistics ledger can be found, in some examples, the asset transfer subsystem 2442 issues 2416 a lock token directed at (i.e., containing hash of) the physical object state token for that real-world asset/object. This lock-token signifies that no further changes can be made to the state token until an unlock-token has followed later (or the lock-token has time-out/expired).

Issuance of lock on asset instance on trade ledger: Once the real-world asset (on the physical logistics ledger 1032) has been locked (i.e., disabled from further changes), the asset transfer subsystem 2442 issues 2418 a lock token on the asset trading ledger 1020 on the relevant asset instance registered on the asset trading ledger 1020. This lock prevents the current owner of the asset instance (whose ownership is recorded in the asset ownership token) from selling the asset instance until the lock is removed (i.e., when an unlock token issued). In general, potential buyers of assets can ensure that an asset is fully available by simply looking for locks on the trading ledger that has been set for that asset.

Issuance of locks on object avatar state tokens on metaverse tracking ledger: Since the asset instance on the asset trading ledger 1020 has been locked, in some examples, the current owner of the asset is to be prevented from selling the asset via the metaverse. This is signaled by the asset transfer subsystem 2442 issuing 2420 a lock on the object avatar state tokens (corresponding to the asset) in one or more metaverse (e.g., as illustrated in FIG. 15).

It is noted that for one asset instance on the trading ledger, the owner (user) of that asset token can display an object avatar for that asset in different metaverses simultaneously. The user can only show one object avatar in any given metaverse, but the user may participate in N metaverses at any given time. This means that a lock token is to be issued for each of the N object avatar state tokens on the tracking ledger.

Signaling commit ready: Once the relevant locks have been issued on the asset trading ledger, the metaverse tracking ledger, and the physical logistics ledger, the asset transfer subsystem 2422 signals to the buyer that the asset transfer subsystem 2442 is ready to commit to the trade between the buyer and seller.

### Phase 3: Commitment to the Transfer of the Asset

In Phase-3 of the asset trading protocol, the goal of the asset transfer subsystem 2442 is to commit (or abort) the entire asset trade/sale.

Buyer release of the escrow to the seller and providing evidence: In order to indicate the buyer's willingness to proceed with the trade/sale, in some examples, the buyer takes action by instructing 2424 the escrow entity to release the escrowed funds to the seller 2402 and issuing 2426 a signed certificate of evidence of escrow release. The buyer 2400 then records 2428 the escrow release evidence certificate onto the asset trading ledger 1020.

Issuance of a new asset ownership token on the trading ledger: Upon seeing the confirmation on the asset trading ledger 1020 of the escrow release (from the buyer), the asset transfer subsystem 2442 proceeds to issue 2430 a new asset ownership token (for the asset instance), assigned to the trading public key of the buyer 2400. Thus, the digital signature on the new asset ownership token is to be performed by the asset transfer subsystem 2442 as the issuing authority (e.g., as illustrated in FIG. 12).

Invalidating the object avatar state tokens on the metaverse tracking ledger: Once the new asset ownership token has been confirmed (finalized) on the asset trading ledger 1020, in some examples, the asset transfer subsystem 2442 searches through the metaverse tracking ledger 1000 for branded object state tokens (e.g., as illustrated in FIG. 15) that refer to (e.g., contains a hash of) the old asset ownership token. For each branded object state token, in some examples, the asset transfer subsystem 2442 issues 2432 an invalidation token that points to (includes a hash of) the state token being invalidated/canceled on the metaverse tracking ledger 1000.

This indicates to other users in the metaverse, e.g., that the asset instance corresponding to the object avatar being displayed in the metaverse has changed ownership. This also implies that the branded object avatar authentication protocol will fail to authenticate the old owner because the asset instance corresponding to the object avatar has a new asset ownership token (it is noted that the old branded object avatar state token still points to the old ownership token).

Unlocking the physical object state token on the logistics ledger: In some examples, the asset transfer subsystem 2442 then releases 2434 the lock placed on the physical object state token on the physical logistics ledger 1032. After this lock has been released, the depository entity issues a new repository receipt to reconfirm that the physical object remains in the hands of the depository (but its ownership has changed hands). The asset transfer subsystem 2442 can then further send 2436 a transaction complete message to the buyer 2400 and send 2438 a transaction complete message to the seller 2402.

Note that the new owner of a singularity/duality asset can obtain a copy of the branded object avatar image file from either the seller or the brand owner (manufacturer). This can be obtained out-of-band, e.g., once Phase-3 has been completed.

### Leasing and Lending Assets in the Metaverse

Some types of assets may be lent out or leased out by one user (its current owner) to another user (borrower or lease-holder). This means that that the ownership of the asset remains unchanged, but its current owner has no control of the asset until it is returned to the owner. The term “loan” is used herein when there is no corresponding payment (in one form or another) and the term “lease” when there is payment from the borrower to the owner.

### Asset Leases for Singularity or Duality

In some examples, the leasing (or lending) of metaverse assets can be implemented as follows:

Leasing singularity assets: When a singularity asset is loaned out from its owner user “U1” to a borrower user “U2” for a fixed duration of time T, it means that the owner ceases control over the registered object avatar representing the singularity asset in all metaverses for that duration of time T.

Leasing duality assets: When a duality asset is loaned out from its owner user “U1” to a borrower user “U2” for a fixed duration of time T, it means that owner ceases control over both (i) the registered object avatar representing the duality asset in all metaverses, and (ii) the real-world asset that corresponds to the registered object avatar, for that duration of time T.

There are some notable implications to the notion of a lease (loan) of an asset, particularly in the context of a branded metaverse asset associated with a brand owner of manufacturer:

The owner is temporarily disabled from displaying the branded object avatar within all metaverses. On the other hand, the borrower is temporarily enabled to wield or display the branded object avatar within the metaverse of their choice. The owner has provided legal custody of the real-world physical asset to the borrower for time duration T. This means that the borrower (person) can obtain physical access of the real-world physical asset from the owner or a depository that holds the physical asset.

In the case of when the borrower does obtain physical access of the real-world physical asset (e.g., Gucci® bag, artwork, etc.), a physical asset check-out protocol is employed by the depository which records a check-out receipt on the logistics ledger. This check-out receipt is signed by the borrower and indicates that (a) the borrower has taken physical possession of the real-world physical asset for the duration of time T, and that (b) the borrower has legally agreed to return the real-world physical asset before time T expires. When the borrower returns the real-world physical asset to the depository, a check-in receipt is issued on the physical logistics ledger 1032 that matches (pairs) with the previous check-out receipt. The check-in receipt is to be signed by the depository.

### The Asset Lease Protocol and the Asset Lease Token

When the owner of the asset intends to lease or loan the asset to a borrower, in some examples, the owner and borrower use computing devices to perform the asset lease protocol, which triggers the asset consistency management system 100 to maintain consistency of state of the asset representations across the three decentralized ledgers. Similar to above, in some examples, each of the “owner” and “borrower” can represent computing devices, e.g., used by users to access an asset consistency management system 100, metaverses, and other networked computing services via a computing network. Among others, the following tasks are carries out within the asset lease protocol in connection to the asset lease from its owner user U1 to a borrower user U2 for a fixed duration of time T:

Asset lease token on the asset trading ledger: The owner issues an asset lease token on the asset trading ledger 1020 that specifies the borrower's public key and the time duration T.

Time-lock on the asset ownership token on trading ledger: Seeing the asset lease token on the asset trading ledger 1020, the asset consistency management system 100 responds by issuing a time-lock on the asset ownership token on the asset trading ledger 1020. This is done by the asset consistency management system 100 to prevent the change of ownership during time T. The time-lock parameter corresponds to the time T.

Time-lock of object avatar state tokens on the asset trading ledger: The asset consistency management system 100 also issues a time-lock on all object avatar state tokens (for that asset) that were previously registered by its owner on the asset trading ledger 1020. This is done by the asset consistency management system 100 to prevent owner from changing the object avatar state tokens and introducing new ones on the asset trading ledger 1020. The time-lock parameter corresponds to the time T.

A summary of the asset lease protocol follows the phases of the asset trading protocol described elsewhere herein with the overall distinction that the ownership of the asset does not change and that after time T the control over the metaverse asset reverts back to its legal owner:

Phase-1: The owner and the borrower agree on the duration time T of the lease. The owner has to identify the specific asset that is being leased by inputting (e.g., into the smart contract implementing the lease protocol) its asset ownership token.

Phase-2: Seeing the request to lease the asset (between the owner and borrower), the asset consistency management system 100 places locks on the (i) the asset instance on the asset trading ledger 1020, the object avatar state tokens (for that asset) on the metaverse tracking ledger 1000 and a lock on the physical object state token on the physical logistics ledger 1032. Once these locks have been confirmed on the ledgers, the asset consistency management system 100 asks for a commitment from the owner.

Phase-3: After the asset owner acknowledges the commitment request from the asset consistency management system 100, the asset consistency management system 100 system issues an asset lease token that identifies the public key of the borrower in the token and the asset consistency management system 100 system runs a clock that counts down from T to zero. The asset lease token is similar to the data structure for the asset ownership token (e.g., illustrated in FIG. 12) except that its token type clearly identifies this event as a “lease” (not a trade) and that a time T is stated in the token as the duration of the lease.

Phase-4: Once the timer/clock completes counting down from T to zero, the asset lease token automatically expires. At this point, the asset consistency management system 100 (i) invalidates all the borrower's state tokens (i.e., object state tokens for the asset on the metaverse tracking ledger 1000, (ii) unlocks the physical object state token on the physical logistics ledger 1032, and (iii) clears other pending locks related to the lease event.

### Orphaned Duality Assets: Lost & Found

It is noted that there may be dishonest borrowers who gain physical access to the real-world physical asset (e.g., a Gucci® bag) from the depository, checks out the item but fails to returns the physical asset within the time limit T.

If after duration time T the borrower has not returned the real-world physical asset to the depository, in some examples, the depository entity issues a physical item lost receipt on the physical logistics ledger 1032, indicating to the asset owner (and everyone else) that the depository legally considers the real-world physical asset to be henceforth considered as unavailable (lost or stolen). This signals to potential buyers of the duality asset that incorporates the lost real-world physical asset not to purchase the duality asset. A duality asset whose real-world physical asset component is unavailable is referred to an orphaned duality asset.

If in the future (after time T expires) the borrower does return the real-world physical asset to the depository, in some examples, the depository entity issues a physical item found receipt on the physical logistics ledger, indicating to the asset owner (and everyone else) that the depository legally considers the real-world physical asset to be returned. This changes the state of the duality asset from being orphaned-state to being complete-state again.

### EXAMPLES

In some examples, a computer-implemented asset consistency management system (asset consistency management system 100) ensures the consistency of the state of persons (person avatars), objects (object avatars), and venues (venue avatars) within a metaverse. In some examples, a computer-implemented waterfall ledger architecture provides mutually reinforcing ledgers, where changes in one ledger can be propagated to other ledgers with synchronization and achieving consistency of state and data across the ledgers.

In some examples, an object metaverse asset takes the form of an object facsimile (e.g., an image file or other data that can be used to produce a visual representation of an object) which can be legally purchased or traded by a user in a metaverse. Once the object is legally acquired by a person or entity, it belongs to the person or entity until such time the owner sells/trade it.

In some examples, a venue access asset consists of permission to access to a meta-venue within a metaverse. A user or other entity obtains (e.g., purchase or trade for) a venue access token, which has a time-limit of validity (i.e., for a given event in the venue). If the meta-venue is bound to physical venue in the real-world, then the venue access token in the metaverse may also provide its holder with access to the physical venue.

In some examples, a meta-venue is private area or resource within a metaverse that is controlled by a venue owner. It can be implemented using a hardware-based secure enclave technology that provides a confidential computing container. All actions of entities and objects in the meta-venue occurs within confidential computing container that executes within the trusted execution environment of the hardware. A given meta-venue may bound to physical venue in the real-world, and access to one may automatically give access to the other.

In some examples, a metaverse singularity asset where, the digital image (such as an avatar image) is the asset itself. A singularity asset is not bound to any real-world objects or persons and exists only within the metaverses for which it is designed to exist. A singularity asset can be defined to exist in one metaverse only, or it can be defined to be movable across multiple metaverses.

In some examples, a metaverse duality asset is a bound combination of a digital image or other digital representation of the asset (e.g., avatar image) and a real-world asset. The digital image in the metaverse is bound (e.g., cryptographically) to a real-world asset. Possession of this type of asset by a user signifies that the user that legally owns the metaverse asset also legally owns the real-world asset.

In some examples, a metaverse authentication protocol for user-avatars and object-avatars permits entities interacting in a metaverse to cryptographically challenge the identity authenticity of other entities, and to request entities wielding objects in a metaverse to cryptographically prove that the object correspond to genuine real-world assets.

In some examples, a metaverse asset trading protocol can perform buy/sell transactions of metaverse assets (either singularity asset or duality asset) between a buyer and seller (e.g., using respective computing devices) on the trading ledger. The protocol performs asset consistency maintenance using the relevant locking (and unlocking) of the assets and tokens in the three decentralized ledgers of the asset consistency management system 100. The protocol is used for the sale/trade of singularity assets or duality assets and ensures the consistency of the states of the three ledgers before and after the asset sale/trade. In the case of a duality asset, the protocol also ensures that the real-world physical asset/goods have been placed under the control of a trusted depository.

In some examples, a metaverse event that occurs either in the metaverse only (singularity event) or in both the metaverse and the real-world physical venue simultaneously (duality event). Access to a metaverse event is subject to a party possessing (e.g., purchasing) an instance of the singularity or duality ticket-asset instance prior to the occurrence of the event. An Event Branded-Asset is when a metaverse asset (singularity or duality) is available for purchase/trade only during the duration of a metaverse event.

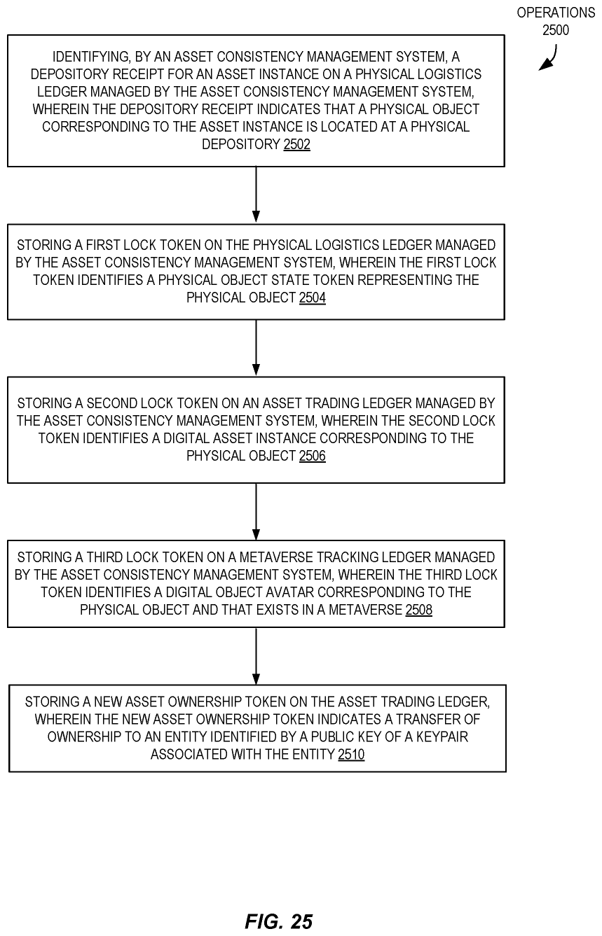

FIG. 25 is a flow diagram illustrating operations 2500 of a method for providing an asset trading protocol involving asset instances used in one or more metaverses according to some examples. Some or all the operations 2500 (or other processes described herein, or variations, and/or combinations thereof) are performed under the control of one or more computer systems configured with executable instructions, and are implemented as code (e.g., executable instructions, one or more computer programs, or one or more applications) executing collectively on one or more processors. The code is stored on a computer-readable storage medium, for example, in the form of a computer program comprising instructions executable by one or more processors. The computer-readable storage medium is non-transitory. In some examples, one or more (or all) of the operations 2500 are performed by an asset consistency management system 100 of the other figures.

The operations 2500 include, at block 2502, identifying, by an asset consistency management system, a depository receipt for an asset instance on a physical logistics ledger managed by the asset consistency management system, wherein the depository receipt indicates that a physical object corresponding to the asset instance is located at a physical depository.

The operations 2500 further include, at block 2504, storing a first lock token on the physical logistics ledger managed by the asset consistency management system, wherein the first lock token identifies a physical object state token representing the physical object.

The operations 2500 further include, at block 2506, storing a second lock token on an asset trading ledger managed by the asset consistency management system, wherein the second lock token identifies a digital asset instance corresponding to the physical object.

The operations 2500 further include, at block 2508, storing a third lock token on a metaverse tracking ledger managed by the asset consistency management system, wherein the third lock token identifies a digital object avatar corresponding to the physical object and that exists in a metaverse.

The operations 2500 further include, at block 2510, storing a new asset ownership token on the asset trading ledger, wherein the new asset ownership token indicates a transfer of ownership to an entity identified by a public key of a keypair associated with the entity.

In some examples, the digital object avatar is an accessory displayed in connection with a user avatar in the metaverse.

In some examples, the digital object avatar is a clothing item worn by a user avatar in the metaverse.

In some examples, the digital object avatar includes a graphical element indicating an association with a manufacturer of the physical object.

In some examples, the digital asset instance is generated by based on a duality asset definition, wherein the duality asset definition includes a description of duality assets generated based on the duality asset definition, a maximum number of duality asset instances permitted based on the duality asset definition, and a number of composite parts associated with the duality asset definition.

In some examples, the digital asset instance is part of a composite set of digital asset instances, and wherein transfer of ownership to the entity involves transfer of ownership of each digital asset instance of the composite set of digital asset instances.

In some examples, the digital asset instance is generated based on a duality asset definition defined by an entity that manufactures the physical object.

In some examples, the metaverse is one of: a social networking environment, a gaming environment, or an augmented reality environment.

In some examples, the asset consistency management system, the physical logistics ledger, the asset trading ledger, and the metaverse tracking ledger execute using computing resources provided by a cloud provider network.

In some examples, the operations 2500 further include invalidating, by the asset consistency management system, an object avatar state token associated with a previous owner of the digital asset instance.

### Implementation Mechanism—Hardware Overview

According to one example, the techniques described herein (e.g., related to the asset consistency management system 100 and other components) are implemented by one or more special-purpose computing devices. The special-purpose computing devices may be desktop computer systems, portable computer systems, handheld devices, networking devices or any other device that incorporates hard-wired and/or program logic to implement the techniques. The special-purpose computing devices may be hard-wired to perform the techniques or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination thereof. Such special-purpose computing devices may also combine custom hard-wired logic, ASICs, or FPGAs with custom programming to accomplish the techniques.

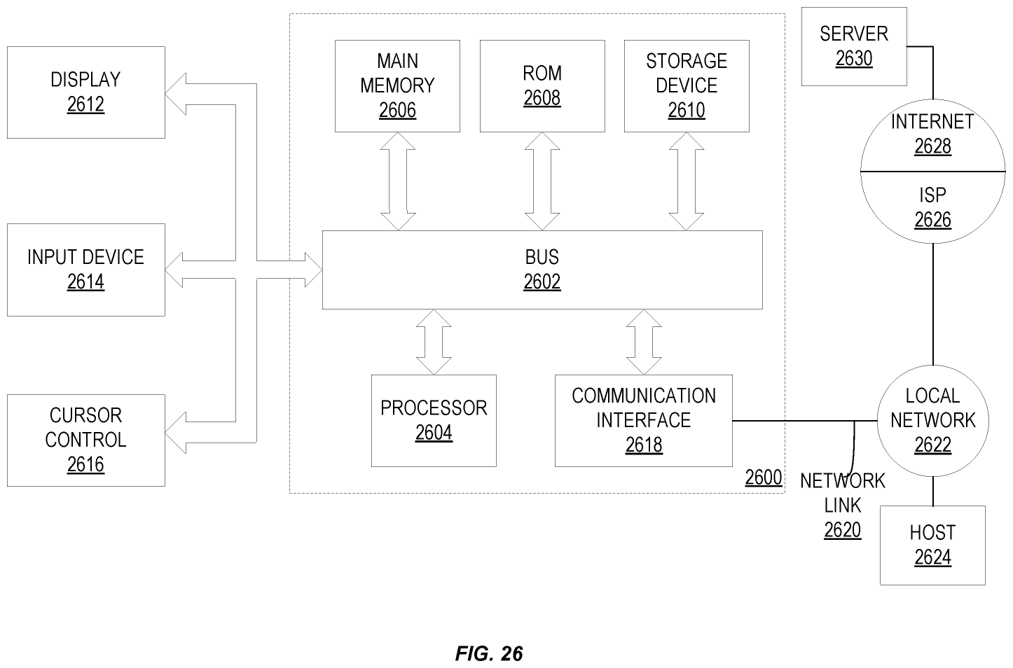

FIG. 26 is a block diagram that illustrates a computer system 2600 utilized in implementing the above-described techniques, according to an example. Computer system 2600 may be, for example, a desktop computing device, laptop computing device, tablet, smartphone, server appliance, computing mainframe, multimedia device, handheld device, networking apparatus, or any other suitable device.

Computer system 2600 includes one or more buses 2602 or other communication mechanism for communicating information, and one or more hardware processors 2604 coupled with buses 2602 for processing information. Hardware processors 2604 may be, for example, general purpose microprocessors. Buses 2602 may include various internal and/or external components, including, without limitation, internal processor or memory buses, a Serial ATA bus, a PCI Express bus, a Universal Serial Bus, a HyperTransport bus, an Infiniband bus, and/or any other suitable wired or wireless communication channel.

Computer system 2600 also includes a main memory 2606, such as a random access memory (RAM) or other dynamic or volatile storage device, coupled to bus 2602 for storing information and instructions to be executed by processor 2604. Main memory 2606 also may be used for storing temporary variables or other intermediate information during execution of instructions to be executed by processor 2604. Such instructions, when stored in non-transitory storage media accessible to processor 2604, render computer system 2600 a special-purpose machine that is customized to perform the operations specified in the instructions.

Computer system 2600 further includes one or more read only memories (ROM) 2608 or other static storage devices coupled to bus 2602 for storing static information and instructions for processor 2604. One or more storage devices 2610, such as a solid-state drive (SSD), magnetic disk, optical disk, or other suitable non-volatile storage device, is provided and coupled to bus 2602 for storing information and instructions.

Computer system 2600 may be coupled via bus 2602 to one or more displays 2612 for presenting information to a computer user. For instance, computer system 2600 may be connected via a High-Definition Multimedia Interface (HDMI) cable or other suitable cabling to a Liquid Crystal Display (LCD) monitor, and/or via a wireless connection such as peer-to-peer Wi-Fi Direct connection to a Light-Emitting Diode (LED) television. Other examples of suitable types of displays 2612 may include, without limitation, plasma display devices, projectors, cathode ray tube (CRT) monitors, electronic paper, virtual reality headsets, braille terminal, and/or any other suitable device for outputting information to a computer user. In an example, any suitable type of output device, such as, for instance, an audio speaker or printer, may be utilized instead of a display 2612.

One or more input devices 2614 are coupled to bus 2602 for communicating information and command selections to processor 2604. One example of an input device 2614 is a keyboard, including alphanumeric and other keys. Another type of user input device 2614 is cursor control 2616, such as a mouse, a trackball, or cursor direction keys for communicating direction information and command selections to processor 2604 and for controlling cursor movement on display 2612. This input device typically has two degrees of freedom in two axes, a first axis (e.g., x) and a second axis (e.g., y), that allows the device to specify positions in a plane. Yet other examples of suitable input devices 2614 include a touch-screen panel affixed to a display 2612, cameras, microphones, accelerometers, motion detectors, and/or other sensors. In an example, a network-based input device 2614 may be utilized. In such an example, user input and/or other information or commands may be relayed via routers and/or switches on a Local Area Network (LAN) or other suitable shared network, or via a peer-to-peer network, from the input device 2614 to a network link 2620 on the computer system 2600.

A computer system 2600 may implement techniques described herein using customized hard-wired logic, one or more ASICs or FPGAs, firmware and/or program logic which in combination with the computer system causes or programs computer system 2600 to be a special-purpose machine. According to one example, the techniques herein are performed by computer system 2600 in response to processor 2604 executing one or more sequences of one or more instructions contained in main memory 2606. Such instructions may be read into main memory 2606 from another storage medium, such as storage device 2610. Execution of the sequences of instructions contained in main memory 2606 causes processor 2604 to perform the process steps described herein. In alternative examples, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 2610. Volatile media includes dynamic memory, such as main memory 2606. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, an EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 2602. Transmission media can also take the form of acoustic or light waves, such as those generated during radio-wave and infra-red data communications.

Various forms of media may be involved in carrying one or more sequences of one or more instructions to processor 2604 for execution. For example, the instructions may initially be carried on a magnetic disk or a solid-state drive of a remote computer. The remote computer can load the instructions into its dynamic memory and use a modem to send the instructions over a network, such as a cable network or cellular network, as modulate signals. A modem local to computer system 2600 can receive the data on the network and demodulate the signal to decode the transmitted instructions. Appropriate circuitry can then place the data on bus 2602. Bus 2602 carries the data to main memory 2606, from which processor 2604 retrieves and executes the instructions. The instructions received by main memory 2606 may optionally be stored on storage device 2610 either before or after execution by processor 2604.

A computer system 2600 may also include, in an example, one or more communication interfaces 2618 coupled to bus 2602. A communication interface 2618 provides a data communication coupling, typically two-way, to a network link 2620 that is connected to a local network 2622. For example, a communication interface 2618 may be an integrated services digital network (ISDN) card, cable modem, satellite modem, or a modem to provide a data communication connection to a corresponding type of telephone line. As another example, the one or more communication interfaces 2618 may include a local area network (LAN) card to provide a data communication connection to a compatible LAN. As yet another example, the one or more communication interfaces 2618 may include a wireless network interface controller, such as a 802.11-based controller, Bluetooth controller, Long Term Evolution (LTE) modem, and/or other types of wireless interfaces. In any such implementation, communication interface 2618 sends and receives electrical, electromagnetic, or optical signals that carry digital data streams representing various types of information.

Network link 2620 typically provides data communication through one or more networks to other data devices. For example, network link 2620 may provide a connection through local network 2622 to a host computer 2624 or to data equipment operated by a Service Provider 2626. Service Provider 2626, which may for example be an Internet Service Provider (ISP), in turn provides data communication services through a wide area network, such as the worldwide packet data communication network now commonly referred to as the “Internet” 2628. Local network 2622 and Internet 2628 both use electrical, electromagnetic, or optical signals that carry digital data streams. The signals through the various networks and the signals on network link 2620 and through communication interface 2618, which carry the digital data to and from computer system 2600, are example forms of transmission media.

In an example, computer system 2600 can send messages and receive data, including program code and/or other types of instructions, through the network(s), network link 2620, and communication interface 2618. In the Internet example, a server 2630 might transmit a requested code for an application program through Internet 2628, ISP 2626, local network 2622 and communication interface 2618. The received code may be executed by processor 2604 as it is received, and/or stored in storage device 2610, or other non-volatile storage for later execution. As another example, information received via a network link 2620 may be interpreted and/or processed by a software component of the computer system 2600, such as a web browser, application, or server, which in turn issues instructions based thereon to a processor 2604, possibly via an operating system and/or other intermediate layers of software components.

In an example, some or all of the systems described herein may be or comprise server computer systems, including one or more computer systems 2600 that collectively implement various components of the system as a set of server-side processes. The server computer systems may include web server, application server, database server, and/or other conventional server components that certain above-described components utilize to provide the described functionality. The server computer systems may receive network-based communications comprising input data from any of a variety of sources, including without limitation user-operated client computing devices such as desktop computers, tablets, or smartphones, remote sensing devices, and/or other server computer systems.

In an example, certain server components may be implemented in full or in part using “cloud”-based components that are coupled to the systems by one or more networks, such as the Internet. The cloud-based components may expose interfaces by which they provide processing, storage, software, and/or other resources to other components of the systems. In an example, the cloud-based components may be implemented by third-party entities, on behalf of another entity for whom the components are deployed. In other examples, however, the described systems may be implemented entirely by computer systems owned and operated by a single entity.

In an example, an apparatus comprises a processor and is configured to perform any of the foregoing methods. In an example, a non-transitory computer readable storage medium, storing software instructions, which when executed by one or more processors cause performance of any of the foregoing methods.

### Extensions and Alternatives

As used herein, the terms “first,” “second,” “certain,” and “particular” are used as naming conventions to distinguish queries, plans, representations, steps, objects, devices, or other items from each other, so that these items may be referenced after they have been introduced. Unless otherwise specified herein, the use of these terms does not imply an ordering, timing, or any other characteristic of the referenced items.

In the foregoing specification, examples of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. In this regard, although specific claim dependencies are set out in the claims of this application, it is to be noted that the features of the dependent claims of this application may be combined as appropriate with the features of other dependent claims and with the features of the independent claims of this application, and not merely according to the specific dependencies recited in the set of claims. Moreover, although separate examples are discussed herein, any combination of examples and/or partial examples discussed herein may be combined to form further examples.

Any definitions expressly set forth herein for terms contained in such claims shall govern the meaning of such terms as used in the claims. Hence, no limitation, element, property, feature, advantage, or attribute that is not expressly recited in a claim should limit the scope of such claim in any way. The specification and drawings are, accordingly, to be regarded in an illustrative rather than a restrictive sense.

What is claimed is:

1. A computer-implemented method comprising:
identifying, by an asset consistency management system, a depository receipt for an asset instance on a physical logistics ledger managed by the asset consistency management system, wherein the depository receipt indicates that a physical object corresponding to the asset instance is located at a physical depository;
storing a first lock token on the physical logistics ledger managed by the asset consistency management system, wherein the first lock token identifies a physical object state token representing the physical object;
storing a second lock token on an asset trading ledger managed by the asset consistency management system, wherein the second lock token identifies a digital asset instance corresponding to the physical object;
storing a third lock token on a metaverse tracking ledger managed by the asset consistency management system, wherein the third lock token identifies a digital object avatar corresponding to the physical object and that exists in a metaverse; and
storing a new asset ownership token on the asset trading ledger, wherein the new asset ownership token indicates a transfer of ownership to an entity identified by a public key of a keypair associated with the entity.

2. The computer-implemented method of claim 1, wherein the digital object avatar is an accessory displayed in connection with a user avatar in the metaverse.

3. The computer-implemented method of claim 1, wherein the digital object avatar is a clothing item worn by a user avatar in the metaverse.

4. The computer-implemented method of claim 1, wherein the digital object avatar includes a graphical element indicating an association with a manufacturer of the physical object.

5. The computer-implemented method of claim 1, wherein the digital asset instance is generated by based on a duality asset definition, wherein the duality asset definition includes a description of duality assets generated based on the duality asset definition, a maximum number of duality asset instances permitted based on the duality asset definition, and a number of composite parts associated with the duality asset definition.

6. The computer-implemented method of claim 1, wherein the digital asset instance is part of a composite set of digital asset instances, and wherein transfer of ownership to the entity involves transfer of ownership of each digital asset instance of the composite set of digital asset instances.

7. The computer-implemented method of claim 1, wherein the digital asset instance is generated based on a duality asset definition defined by an entity that manufactures the physical object.

8. The computer-implemented method of claim 1, wherein the metaverse is one of: a social networking environment, a gaming environment, or an augmented reality environment.

9. The computer-implemented method of claim 1, wherein the asset consistency management system, the physical logistics ledger, the asset trading ledger, and the metaverse tracking ledger execute using computing resources provided by a cloud provider network.

10. The computer-implemented method of claim 1, further comprising invalidating, by the asset consistency management system, an object avatar state token associated with a previous owner of the digital asset instance.

11. A system comprising:
a first one or more electronic devices to implement an asset consistency management system, wherein the asset consistency management system includes instructions that upon execution cause the asset consistency management system to:
identify, by an asset consistency management system, a depository receipt for an asset instance on a physical logistics ledger managed by the asset consistency management system, wherein the depository receipt indicates that a physical object corresponding to the asset instance is located at a physical depository,
store a first lock token on the physical logistics ledger managed by the asset consistency management system, wherein the first lock token identifies a physical object state token representing the physical object,
store a second lock token on an asset trading ledger managed by the asset consistency management system, wherein the second lock token identifies a digital asset instance corresponding to the physical object,
store a third lock token on a metaverse tracking ledger managed by the asset consistency management system, wherein the third lock token identifies a digital object avatar corresponding to the physical object and that exists in a metaverse, and
store a new asset ownership token on the asset trading ledger, wherein the new asset ownership token indicates a transfer of ownership to an entity identified by a public key of a keypair associated with the entity; and
a second one or more electronic devices to implement the physical logistics ledger, the asset trading ledger, and the metaverse tracking ledger, wherein the physical logistics ledger, the asset trading ledger, and the metaverse tracking ledger include instructions that upon execution cause the physical logistics ledger, the asset trading ledger, and the metaverse tracking ledger to:
store the first lock token, second lock token, and the third lock token.

12. The system of claim 11, wherein the digital object avatar is an accessory displayed in connection with a user avatar in the metaverse.

13. The system of claim 11, wherein the digital object avatar is a clothing item worn by a user avatar in the metaverse.

14. The system of claim 11, wherein the digital object avatar includes a graphical element indicating an association with a manufacturer of the physical object.

15. The system of claim 11, wherein the digital asset instance is generated by based on a duality asset definition, wherein the duality asset definition includes a description of duality assets generated based on the duality asset definition, a maximum number of duality asset instances permitted based on the duality asset definition, and a number of composite parts associated with the duality asset definition.

16. A non-transitory computer-readable storage medium storing instructions which, when executed by one or more processors, cause performance of operations including:
identifying, by an asset consistency management system, a depository receipt for an asset instance on a physical logistics ledger managed by the asset consistency management system, wherein the depository receipt indicates that a physical object corresponding to the asset instance is located at a physical depository;
storing a first lock token on the physical logistics ledger managed by the asset consistency management system, wherein the first lock token identifies a physical object state token representing the physical object;
storing a second lock token on an asset trading ledger managed by the asset consistency management system, wherein the second lock token identifies a digital asset instance corresponding to the physical object;
storing a third lock token on a metaverse tracking ledger managed by the asset consistency management system, wherein the third lock token identifies a digital object avatar corresponding to the physical object and that exists in a metaverse; and
storing a new asset ownership token on the asset trading ledger, wherein the new asset ownership token indicates a transfer of ownership to an entity identified by a public key of a keypair associated with the entity.

17. The non-transitory computer-readable storage medium of claim 16, wherein the digital object avatar is an accessory displayed in connection with a user avatar in the metaverse.

18. The non-transitory computer-readable storage medium of claim 16, wherein the digital object avatar is a clothing item worn by a user avatar in the metaverse.

19. The non-transitory computer-readable storage medium of claim 16, wherein the digital object avatar includes a graphical element indicating an association with a manufacturer of the physical object.

20. The non-transitory computer-readable storage medium of claim 16, wherein the digital asset instance is generated by based on a duality asset definition, wherein the duality asset definition includes a description of duality assets generated based on the duality asset definition, a maximum number of duality asset instances permitted based on the duality asset definition, and a number of composite parts associated with the duality asset definition.
